(19) United States
(12) Patent Application Publication
(10) Pub. No.: US 2023/0282122 A1
(43) Pub. Date: Sep. 7, 2023

(54) GEOFENCE MANAGEMENT WITH AN UNMANNED AERIAL VEHICLE

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 18/174,305

(22) Filed: Feb. 24, 2023

Related U.S. Application Data
(60) Provisional application No. 63/316,402, filed on Mar. 3, 2022.

(51) Int. Cl. G08G 5/00; H04W 4/021; G05D 1/10

(52) U.S. Cl. CPC G08G 5/0069; H04W 4/021; G05D 1/106; G08G 5/0017; B64U 10/00

(57) ABSTRACT

Methods, systems, apparatuses, and computer program products for geofence management with an unmanned aerial vehicle (UAV) are disclosed. In a particular embodiment, a method of geofence management with a UAV includes a geofence manager utilizing a first set of sensor data collected by a first set of in-flight UAVs of the UAV system to detect a first object. In this embodiment, the geofence manager also utilizes the first set of sensor data to determine a first location of the detected first object and determines whether the first location of the detected first object is within a geofence of an area.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under (400) feet above ground level (AGL) in airspace where FAA air traffic services are not provided. However, a framework that extends beyond the (400) feet AGL limit is needed. For example, unmanned aircraft that would be used by package delivery services and air taxis may need to travel at altitudes above (400) feet. Such a framework requires technology that will allow the FAA to safely regulate unmanned aircraft.

### SUMMARY

Methods, systems, apparatuses, and computer program products for geofence management with an unmanned aerial vehicle (UAV) are disclosed. In a particular embodiment, a method of geofence management with a UAV includes a geofence manager utilizing a first set of sensor data collected by a first set of in-flight UAVs of the UAV system to detect a first object. In this embodiment, the geofence manager also utilizes the first set of sensor data to determine a first location of the detected first object and determines whether the first location of the detected first object is within a geofence of an area.

In another embodiment, a method of geofence management with a UAV includes a geofence manager utilizing a first set of sensor data collected by a first set of in-flight UAVs of the UAV system, to detect a first object. In this embodiment, the geofence manager utilizes the first set of sensor data to determine a first location of the detected first object and create a geofence around the first location of the detected first object.

In another embodiment, a method of geofence management with a UAV includes a geofence manager receiving location data indicating a first location of a tracking device. In this embodiment, the geofence manager utilizes a first set of sensor data collected by a first set of in-flight UAVs of the UAV system, to detect a first object at the first location of the tracking device. According to this embodiment, the geofence manager also utilizes the first set of sensor data to determine a first identification of the detected first object and determine whether the first identification of the detected first object matches a stored identification of a particular object registered as being associated with the tracking device.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system of geofence management with an unmanned aerial vehicle (UAV) according to at least one embodiment of the present invention;

FIG. 2 is a block diagram illustrating a particular implementation of a system of geofence management with a UAV according to at least one embodiment of the present invention;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 4 is an additional view of the blockchain of FIG. 3A;

FIG. 5 is a block diagram illustrating a particular implementation of a method of geofence management with a UAV according to at least one embodiment of the present invention;

FIG. 6 is a block diagram illustrating a particular implementation of a method of geofence management with a UAV according to at least one embodiment of the present invention;

FIG. 7 is a block diagram illustrating a particular implementation of a method of geofence management with a UAV according to at least one embodiment of the present invention;

FIG. 8 is a block diagram illustrating a particular implementation of a method of geofence management with a UAV according to at least one embodiment of the present invention;

FIG. 9 is a block diagram illustrating a particular implementation of a method of geofence management with a UAV according to at least one embodiment of the present invention;

FIG. 10 is a block diagram illustrating a particular implementation of a method of geofence management with a UAV according to at least one embodiment of the present invention;

FIG. 11 is a block diagram illustrating a particular implementation of a method of geofence management with a UAV according to at least one embodiment of the present invention;

FIG. 12 is a block diagram illustrating a particular implementation of a method of geofence management with a UAV according to at least one embodiment of the present invention;

FIG. 13 is a block diagram illustrating a particular implementation of a method of geofence management with a UAV according to at least one embodiment of the present invention;

FIG. 14 is a block diagram illustrating a particular implementation of a method of geofence management with a UAV according to at least one embodiment of the present invention;

FIG. 15 is a block diagram illustrating a particular implementation of a method of geofence management with a UAV according to at least one embodiment of the present invention;

FIG. 16 is a block diagram illustrating a particular implementation of a method of geofence management with a UAV according to at least one embodiment of the present invention;

FIG. 17 is a block diagram illustrating a particular implementation of a method of geofence management with a UAV according to at least one embodiment of the present invention;

FIG. 18 is a block diagram illustrating a particular implementation of a method of geofence management with a UAV according to at least one embodiment of the present invention;

FIG. 19 is a block diagram illustrating a particular implementation of a method of geofence management with a UAV according to at least one embodiment of the present invention;

FIG. 20 is a block diagram illustrating a particular implementation of a method of geofence management with a UAV according to at least one embodiment of the present invention;

FIG. 21 is a block diagram illustrating a particular implementation of a method of geofence management with a UAV according to at least one embodiment of the present invention;

FIG. 22 is a block diagram illustrating a particular implementation of a method of geofence management with a UAV according to at least one embodiment of the present invention;

FIG. 23 is a block diagram illustrating a particular implementation of a method of geofence management with a UAV according to at least one embodiment of the present invention; and

FIG. 24 is a block diagram illustrating a particular implementation of a method of geofence management with a UAV according to at least one embodiment of the present invention.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

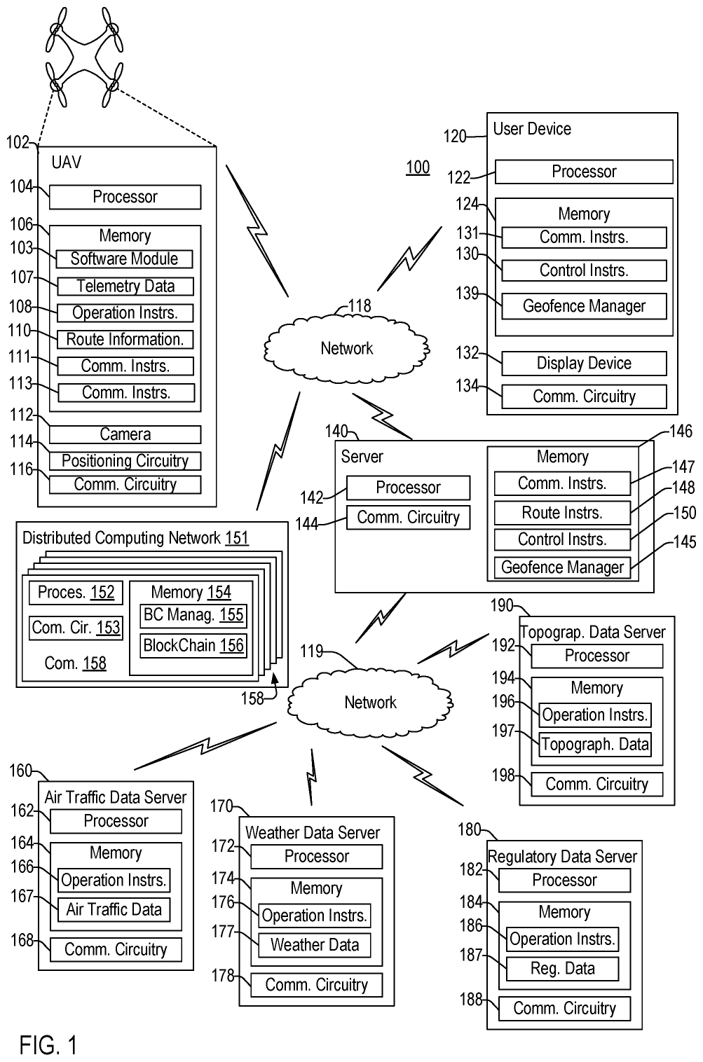

Exemplary methods, apparatuses, and computer program products of geofence management with a UAV in accordance with the present invention are described with reference to the accompanying drawings, beginning with FIG. 1. FIG. 1 sets forth a diagram of a system 100 configured of geofence management with a UAV according to embodiments of the present disclosure. The system 100 of FIG. 1 includes an unmanned aerial vehicle (UAV) 102, a user device 120, a server 140, a distributed computing network 151, an air traffic data server 160, a weather data server 170, a regulatory data server 180, and a topographic data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a user device, and a system of communications between the two. The flight of a UAV may operate with various levels of autonomy including under remote control by a human operator or autonomously by onboard or ground computers. Although a UAV may not include a human operator pilot, some UAVs, such as passenger drones (drone taxi, flying taxi, or pilotless helicopter) carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the user device 120 or the server 140 that sent the incoming message(s). As will be explained further below, the outgoing and incoming messages may be transaction messages that include information associated with the UAV. Thus, in this implementation, communications between the UAV 102, the user device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more user devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of user devices for various points, zones, regions, areas of the flight path. The indicated sets of user devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

The memory 106 of the UAV 102 may also include communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 further includes at least one UAV software module 103. The UAV software module 103 is defined as a group of computer executable code that, when executed by a processor, enables at least one specialized functionality of a UAV that may not normally be present on the UAV. For example, in the embodiment of FIG. 1, the camera 112 may normally be configured to take pictures. The UAV software module 103 may be executed by processor 104 to enable additional functionality of the camera 112, such as object detection or tracking. The UAV software module 103 may work in conjunction with the existing hardware of the UAV 102, such as shown in FIG. 1, or in other examples, the UAV software module 103 may work in conjunction with optional hardware. For example, a UAV software module 103 may work in combination with a sensor not normally present on the UAV 102. In such examples, adding the sensor to the UAV 102 may only be enabled once the appropriate software module is enabled. Likewise, the UAV software module 103 may not be functional unless the additional sensor is present on the UAV 103. Examples of functionality that may be enabled by a software module include, but are not limited to, object detection, automated flight patterns, object tracking, object counting, or responses to object detection.

In the example of FIG. 1, the memory 106 of the UAV 102 further includes a geofence manager 113. In a particular embodiment, the geofence manager 113 includes computer program instructions that when executed by the processor 104 cause the processor 104 to carry out the operations of utilizing a first set of sensor data collected by a first set of the in-flight UAVs of the UAV system to detect a first object; utilizing the first set of sensor data to determine a first location of the detected first object; and determining whether the first location of the detected first object is within a geofence of an area.

In another embodiment, the geofence manager 113 includes computer program instructions that when executed by the processor 104 cause the processor 104 to carry out the operations of utilizing a first set of sensor data collected by a first set of the in-flight UAVs of the UAV system, to detect a first object; utilizing the first set of sensor data to determine a first location of the detected first object; and creating a geofence around the first location of the detected first object.

The user device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the user device 120 and to decrypt incoming message(s) using a public key of a device (e.g., the UAV 102 or the server 140 that sent the incoming message(s). Thus, in this implementation, communication between the UAV 102, the user device 120, and the server 140 are secure and trustworthy (e.g., authenticated).

The processor 122 is configured to execute instructions from the memory 124 to perform various operations. The instructions include control instructions 130 that include instructions or code that cause the user device 120 to generate control data to transmit to the UAV 102 to enable the user device 120 to control one or more operations of the UAV 102 during a particular time period, as further described herein.

In the example of FIG. 1, the memory 124 of the user device 120 also includes communication instructions 131 that when executed by the processor 122 cause the processor 122 to transmit to the distributed computing network 151, messages that include control instructions 130 that are directed to the UAV 102. In a particular embodiment, the transaction messages are also transmitted to the UAV and the UAV takes action (e.g., adjusting flight operations), based on the information (e.g., control data) in the message.

In addition, the memory 124 of the user device 120 may also include a geofence manager 139. In a particular embodiment, the geofence manager 139 includes computer program instructions that when executed by the processor 122 cause the processor 122 to carry out the operations of utilizing a first set of sensor data collected by a first set of the in-flight UAVs of the UAV system to detect a first object; utilizing the first set of sensor data to determine a first location of the detected first object; and determining whether the first location of the detected first object is within a geofence of an area.

In another embodiment, the geofence manager 139 includes computer program instructions that when executed by the processor 122 cause the processor 122 to carry out the operations of utilizing a first set of sensor data collected by a first set of the in-flight UAVs of the UAV system, to detect a first object; utilizing the first set of sensor data to determine a first location of the detected first object; and creating a geofence around the first location of the detected first object.

In another embodiment, the geofence manager 139 includes computer program instructions that when executed by the processor 122 cause the processor 122 to carry out the operations of receiving location data indicating a first location of a tracking device; utilizing a first set of sensor data collected by a first set of the in-flight UAVs of the UAV system, to detect a first object at the first location of the tracking device; utilizing the first set of sensor data to determine a first identification of the detected first object; and determining whether the first identification of the detected first object matches a stored identification of a particular object registered as being associated with the tracking device.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142 is configured to encrypt outgoing message(s) using a private key associated with the server 140 and to decrypt incoming message(s) using a public key of a device (e.g., the UAV 102 or the user device 120 that sent the incoming message(s). As will be explained further below, the outgoing and incoming messages may be transaction messages that include information associated with the UAV. Thus, in this implementation, communication between the UAV 102, the user device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments.

The instructions may also include control instructions 150 that include instructions or code that cause the server 140 to generate control data to transmit to the UAV 102 to enable the server 140 to control one or more operations of the UAV 102 during a particular time period, as further described herein.

In addition, the memory 146 of the server 140 may also include a geofence manager 145. In a particular embodiment, the geofence manager 145 includes computer program instructions that when executed by the processor 142 cause the processor 142 to carry out the operations of utilizing a first set of sensor data collected by a first set of the in-flight UAVs of the UAV system to detect a first object; utilizing the first set of sensor data to determine a first location of the detected first object; and determining whether the first location of the detected first object is within a geofence of an area.

In another embodiment, the geofence manager 145 includes computer program instructions that when executed by the processor 122 cause the processor 142 to carry out the operations of utilizing a first set of sensor data collected by a first set of the in-flight UAVs of the UAV system, to detect a first object; utilizing the first set of sensor data to determine a first location of the detected first object; and creating a geofence around the first location of the detected first object.

In another embodiment, the geofence manager 145 includes computer program instructions that when executed by the processor 122 cause the processor 142 to carry out the operations of receiving location data indicating a first location of a tracking device; utilizing a first set of sensor data collected by a first set of the in-flight UAVs of the UAV system, to detect a first object at the first location of the tracking device; utilizing the first set of sensor data to determine a first identification of the detected first object; and determining whether the first identification of the detected first object matches a stored identification of a particular object registered as being associated with the tracking device.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers. An example computer 158 of the plurality of computers is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152 is configured to encrypt outgoing message(s) using a private key associated with the computer 158 and to decrypt incoming message(s) using a public key of a device (e.g., the UAV 102, the user device 120, or the server 140 that sent the incoming message(s). As will be explained further below, the outgoing and incoming messages may be transaction messages that include information associated with the UAV 102. Thus, in this implementation, communication between the UAV 102, the user device 120, the server 140, and the distributed computing network 151 are secure and trustworthy (e.g., authenticated).

The processor 152 is configured to execute instructions from the memory 154 to perform various operations. The memory 154 includes a blockchain manager 155 that includes computer program instructions for utilizing an unmanned aerial vehicle for emergency response. Specifically, the blockchain manager 155 includes computer program instructions that when executed by the processor 152 cause the processor 152 to receive a transaction message associated with a UAV. For example, the blockchain manager may receive transaction messages from the UAV 102, the user device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV 102.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the user device 120, and the server 140 are communicatively coupled via a network 118. For example, the network 118 may include a satellite network or another type of network that enables wireless communication between the UAV 102, the user device 120, the server 140, and the distributed computing network 151. In an alternative implementation, the user device 120 and the server 140 communicate with the UAV 102 via separate networks (e.g., separate short-range networks.

In some situations, minimal (or no) manual control of the UAV 102 may be performed, and the UAV 102 may travel from the origin to the destination without incident. In some examples, a UAV software module may enable the minimal (or no) manual control operation of the UAV 102. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the user device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the user device 120, the server 140, and any other user devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple devices of the system 100 in a manner that maintains security of the shared blockchain data structure as a public (i.e., available to other devices) and incorruptible (or tamper evident) ledger. Alternatively, as in FIG. 1, the blockchain data structure 156 is stored in a distributed manner in the distributed computing network 151.

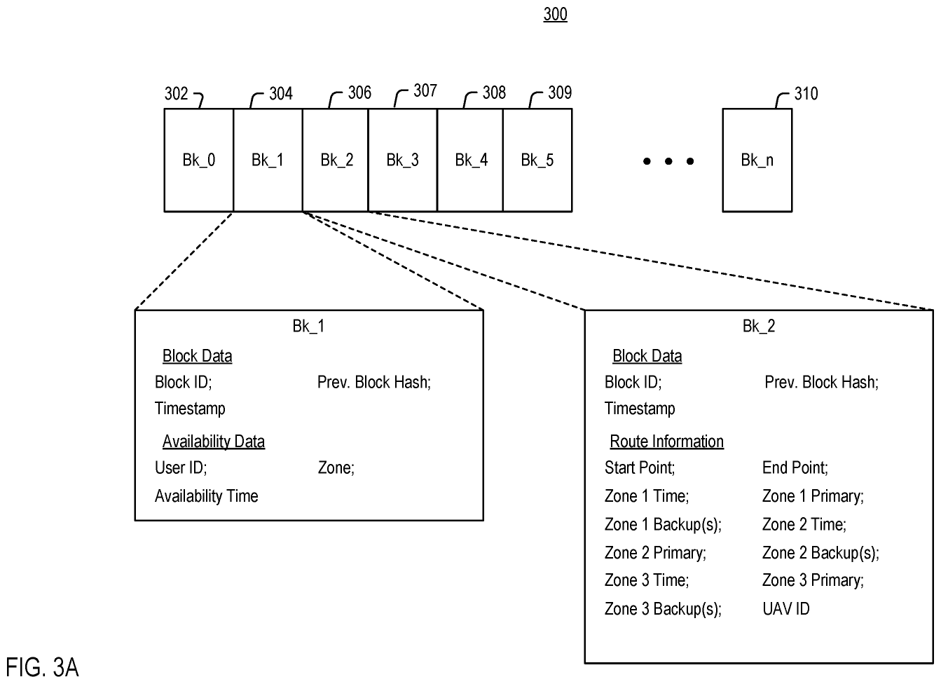

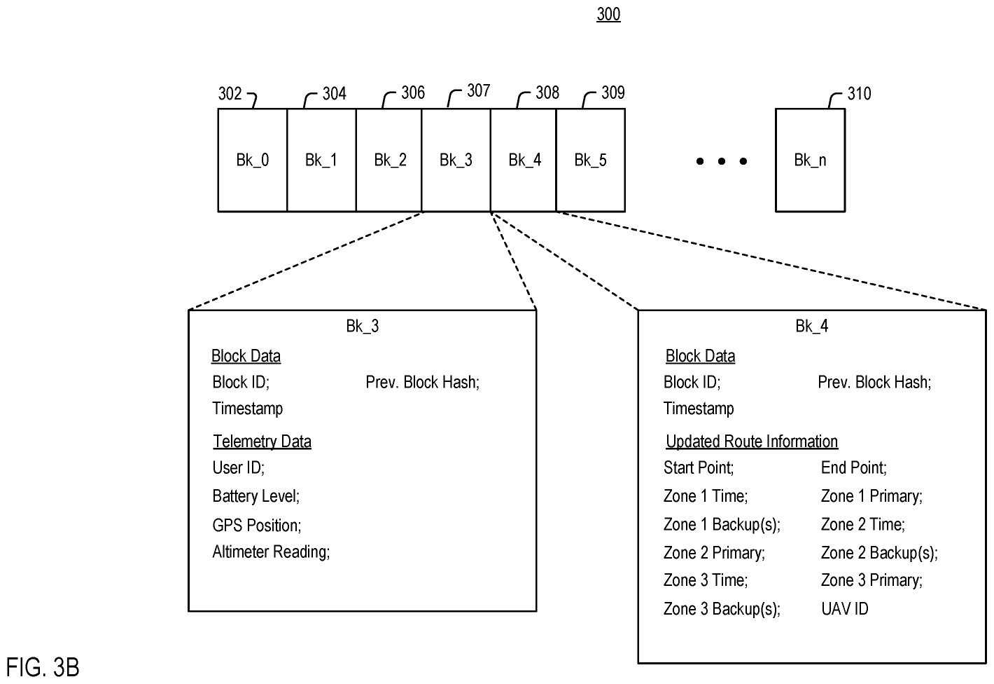

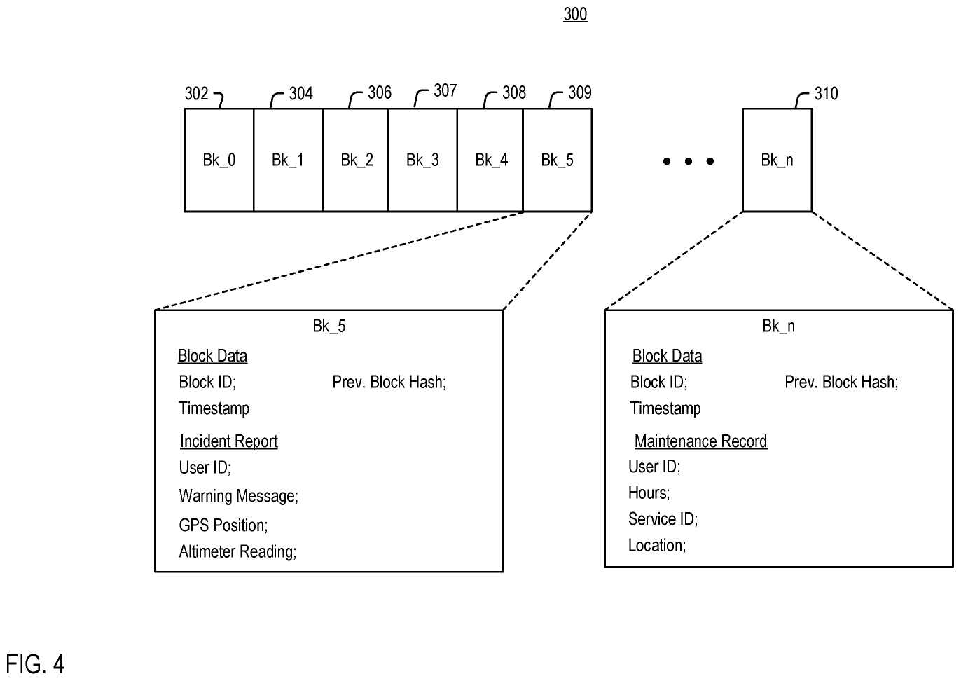

The blockchain data structure 156 may include, among other things, route information associated with the UAV 102, the telemetry data 107, the control instructions 130, and the route instructions 148. For example, the route information 110 may be used to generate blocks of the blockchain data structure 156. A sample blockchain data structure 300 is illustrated in FIGS. 3A, 3B, and 4. Each block of the blockchain data structure 300 includes block data and other data, such as availability data, route data, telemetry data, service information, incident reports, etc.

The block data of each block includes information that identifies the block (e.g., a block ID) and enables the devices of the system 100 to confirm the integrity of the blockchain data structure 300. For example, the block data also includes a timestamp and a previous block hash. The timestamp indicates a time that the block was created. The block ID may include or correspond to a result of a hash function (e.g., a SHA(256) hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, UAV software modules in use, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain data structure 156.

FIG. 3B also depicts the block BK_4 308 as including updated route information having a start point, an endpoint, and a plurality of zone times and backups, along with a UAV ID. In a particular embodiment, the user device 120 or the server 140 may determine that the route of the UAV should be changed. For example, the user device or the server may detect that the route of the UAV conflicts with a route of another UAV or a developing weather pattern. As another example, the user device or the server many determine that the priority level or concerns of the user have changed and thus the route needs to be changed. In such instances, the user device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain data structure 156.

FIG. 4 depicts the block BK_5 309 as including data describing an incident report. In the example of FIG. 4, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 4 also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 may include a UAV software module that is configured to receive telemetry information from an airborne UAV and track the UAV's progress and status. The server 140 is also configured to transmit in-flight commands to the UAV 102. Operation of the user device 120 and the server 140 may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 118 or through direct communication with the server 140. Additionally, communication with each data server may be enabled through the use of a UAV software module as described herein.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 170 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographic data server 190 may include a processor 192, memory 194, and communication circuitry 198. The memory 194 of the topographic data server 190 may include operating instructions 196 that when executed by the processor 192 cause the processor to provide the topographical data that indicates information about terrain, places, structures, transportation, boundaries, hydrography, ortho-imagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, ortho-imagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

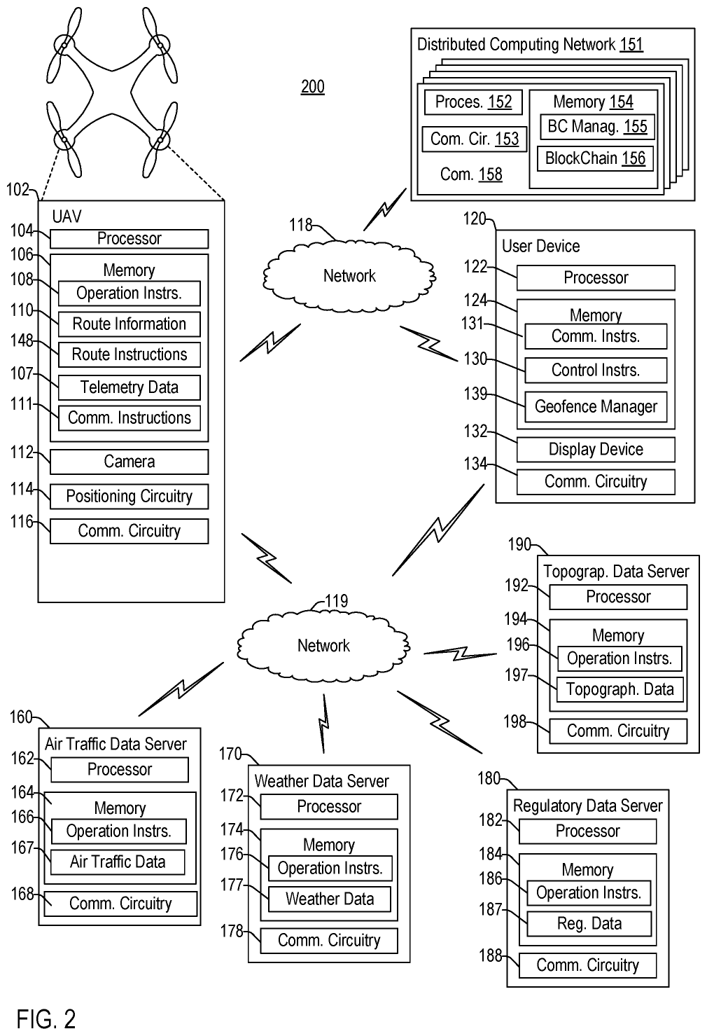

For further explanation, FIG. 2 sets forth a block diagram illustrating another implementation of a system 200 of geofence management with an unmanned aerial vehicle (UAV). Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the user device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

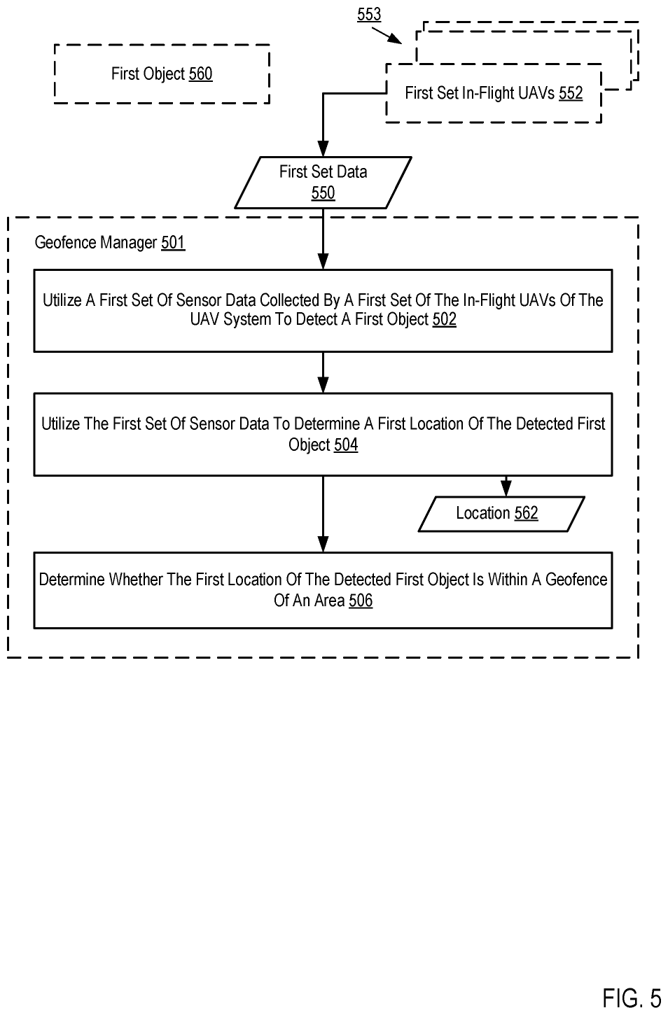

For further explanation, FIG. 5 sets forth a flow chart illustrating an exemplary method of geofence management with an unmanned aerial vehicle (UAV) in accordance with at least one embodiment of the present disclosure. A geofence manager 501 may include a set of computer program instructions that are executed by a processor. For example, the geofence manager 501 of FIG. 5 may be the geofence manager 139 of FIGS. 1 and 2 or the geofence manager 145 of FIG. 1. The method of FIG. 5 includes utilizing 502, by a geofence manager 501, a first set 550 of sensor data collected by a first set 552 of the in-flight UAVs 553 of the UAV system to detect a first object 560.

The sensor data may include data collected from one or more sensors of a UAV (e.g., the UAV 102 of FIG. 1) such as gyroscopes; accelerometers; thermometers; inertial measurement sensors (magnetometer); barometers; GPS sensors; distance sensors (e.g., sensors based on radio detection and ranging; magnetic-field change sensing; sonar-pulse distance sensing (ultrasonic); time of flight (ToF) sensors (range imaging); light-pulse distance sensing (laser); SONAR, RADAR, and LIDAR); optical still or video cameras; monocular or stereo vision cameras; anemometers to measure wind speed and direction; heat detection devices (e.g., infrared sensors, thermal imaging vision cameras, etc); and chemical sensors for the detection of chemicals present in the environment). The sensor data is collected by the UAV and utilized by the UAV for object detection and object identification, or the collected sensor data is streamed to a remote device such as a UAV user device (e.g., the user device 120 of FIG. 1) or a server (e.g., the server 140 of FIG. 1) for object detection and object identification.

In some embodiments, utilizing 502, by a geofence manager 501, a first set 550 of sensor data collected by a first set 552 of the in-flight UAVs 553 of the UAV system to detect a first object 560 is carried out through pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and identification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 560 within the image. Additionally or alternatively, an image of the first object 560 may be generated from LIDAR, RADAR, or SONAR sensor data. For example, line scanning LIDAR may be employed to capture a representation of the first object 560 by illuminating the first object 560 with laser light and measuring the time the reflection of the light takes to return to the sensor. Differences in return times and light wavelengths can then be used to generate a three-dimensional representation of the target.

A variety of sensors may be used to obtain imagery of the detected object 560. In fact, given the variety of sensors equipped on a UAV, sensor data from these sensors may be combined to further enhance an image of the first object 560. For example, an image from a camera may be combined with imagery generated from LIDAR sensor data and imagery generated from SONAR sensor data. The imagery generated from the sensor data of each sensor may be transformed into the same coordinate system (and with the same scale and perspective) such that the images may be overlaid. These image layers may then be flattened into a single image with enhanced features that would not have been detected based on any single sensor. This flattened image may include enhanced features that provide better image resolution for feature detection and extraction.

Feature detection and extraction techniques may be applied to the image to obtain a set of features useful in identifying the first object 560. In some examples, convolution neural networks, support vector machines, and/or deep learning methods are used to extract features of the object and/or identify the object. For example, object recognition techniques such as region-based convolutional neural networks (R-CNN) or You Only Look Once (YOLO) may be useful in identifying, based on the sensor data collected by the in-flight UAVs, a classification of a detected object. In some examples, template-based image matching may be used in which a set of sample points of the extracted features are compared to image templates for object identification. Other object recognition and machine vision techniques, such as optical character recognition (OCR) and shape recognition technology (SRT) may be useful in object recognition and identification. Readers will appreciate that an object may be part of a scene of objects, such that the scene provides context for object identification. A variety of other machine vision and object recognition and identification techniques, as will occur to those of skill in the art, may be utilized to identify an object type of a detected object.

In some examples, utilizing 502, by a geofence manager 501, a first set 550 of sensor data collected by a first set 552 of the in-flight UAVs 553 of the UAV system to detect a first object 560 includes identifying object types that are particularly relevant to UAV operation and UAV missions. For example, exterior artifacts such as structures and vehicles are more likely to be relevant to UAV operation and UAV missions than interior artifacts such as furniture or appliances. As such, the geofence manager 501 may employ a particular set of object classifications for the object. For example, object classifications may include person, animal, vehicle, structure, liquid, vegetation, smoke, fire, and so on, that may be encountered during UAV flight. In some examples, subtypes or particular instances of an object classification, including particular characteristics of the object, may be identified. For example, the object could be a particular person or a particular vehicle. In such instances, the object may be identified using techniques such as facial recognition or other identification techniques. In other examples, the object to be detected can be a set of persons, such as persons having a particular characteristic. In still other examples of subtypes of object classifications, a body of liquid may be further differentiated as a lake, a river, etc.; a structure may be differentiated as a building, a communications tower; etc.; an animal by be differentiated by species, etc.

In some examples, the object classification is identified based on an association with another object. For example, the geofence manager 501 may recognize a tall structure and identify the structure as a high-tension power line structure based on identified power lines attached to it. In another example, a characteristic may include patterns for recognition such as a bar code or quick response (QR) code, an object temperature, a movement characteristic such as smooth or intermittent, a gait style, object emissions, sound patterns, or other characteristics. Identifying the object type of a particular object may rely upon a plurality of sensors. For example, the sensor data may include information from a camera for a visual identification, a microphone for audio detection, a GPS system for identifying location, and/or a thermal sensor for identifying a temperature.

In a particular embodiment, utilizing 502, by a geofence manager 501, a first set 550 of sensor data collected by a first set 552 of the in-flight UAVs 553 of the UAV system to detect a first object 560 includes identifying the classification of the detected object in dependence upon the sensor data and one or more object models. In some examples, identifying the classification of the detected object in dependence upon the sensor data and one or more object models is carried out by the geofence manager 501 loading one or more object models and comparing the object pattern recognized from the sensor data. For example, an artificial neural network may be trained on a set of training images for a particular object to generate an object model for that object. The object model may include a set of features represented by shape context vectors. Once features have been extracted from the object pattern recognized from the image(s) generated from the sensor data, the extracted features may be compared to the set of features for a candidate object model. This comparison may be scored based on the matching of extracted features of the detected object and features of the object model. The process is then repeated for other candidate object models. Based on the scores, a candidate object model may be selected as the matching object model upon which the detected object is classified.

To reduce the amount of computation required to compare the detected object to object models, the entire set of object models may be filtered to produce the set of candidate object models. Filtering may be applied based on characteristics of the detected object or scene, conditions present in the UAV, one or more UAV missions, or combinations thereof. As one simplified example, based on the altitude of the UAV and the camera angle, it may be easily determined that the scene of the image that includes the detected object is a skyscape. This precludes object models that are ground-based such a people, animals, vehicles. Based on a mission of collision avoidance, the set of candidate models may be narrowed based on the altitude of the UAV or the detected object, which may preclude object models for houses and retail stores and small office buildings. Based on the location of the UAV and the pastoral nature of the captured scene (e.g., a rural location, sparsely detected structures, observable greenery), the set of candidate object models may be filtered to exclude an office building, apartment building, or a construction crane. Ultimately, the set of candidate models may be, for example: aircraft, cell tower, or radio tower. If the detected object is actually a radio tower, the comparison of the extracted features of the detected object to the radio tower object model will score high than the comparisons based on the aircraft object model and the cell tower object model.

In some examples, the object models loaded by the geofence manager 501 may be specific to the UAV mission. For example, when the UAV mission is to find people, object models for people are loaded by the geofence manager. When the UAV mission is to find cows, cow object models are loaded by the geofence manager. In this way, the number of candidate object models may be further filtered and thus the number of comparisons may be reduced, thereby conserving computation resources, and expediting a match result.

In some examples where the geofence manager 501 is implemented in the UAV (i.e., the geofence manager 113 of the UAV 102 in FIG. 1), the UAV may be preloaded with a set of object models in the memory of the UAV (e.g., the memory 106 of FIG. 1) prior to executing a mission. For example, the UAV may be preloaded with object models that are specific to the UAV's mission. The UAV may also receive object models in-flight that are transmitted from a remote device (e.g., the user device 120 or the server 140 of FIG. 1).

In some examples where the geofence manager 501 is implemented in a user device (e.g., the geofence manager 139 of the user device 120 of FIG. 1), the user device may store a set of object models locally in the memory of the user device (e.g., the memory 124 of FIG. 1) prior to operating a UAV mission or the user device may receive object models that are transmitted from a remote device (e.g., the server 140 of FIG. 1) while the UAV is in-flight.

In some examples where the geofence manager 501 is implemented in a server (e.g., the geofence manager 145 of the server 140 of FIG. 1), the server may store all object models such that the server acts as a central repository for object models. The server may provide one or more object models from the entire set of object models, where the one or more object models are used in carrying out the UAV mission. In some examples, a standard set of object models may be provided for typical UAV flight operation (e.g., UAV navigation, collision avoidance, and route planning), while a specialized set of object models may be provided for a particular UAV mission.

In addition, the method of FIG. 5 also includes utilizing 504, by the geofence manager 501, the first set 550 of sensor data to determine a first location 562 of the detected first object 560. Utilizing 504, by the geofence manager 501, the first set 550 of sensor data to determine a first location 562 of the detected first object 560 may be carried out by analyzing the first set of sensor data to determine a location 562 of the first object 560 based on the relationship of the first object 560 to one or more known locations. In some examples, the location of the first object 560 may be determined based on the location of the UAV (e.g., x-y or latitude-longitude location), determined from a GPS receiver, the compass orientation of the UAV, and the distance between the UAV and the first object 560 as determined from, for example, LIDAR or SONAR data. The location of the first object 560 may be determined using a variety of techniques based on knowing the location of the UAV from a GPS receiver.

To determine the location of the first object 560, a number of techniques may be employed to determine the distance between the UAV and the first object 560 based on the sensor data. In one example, stereo cameras are used to capture two images of the object from different viewpoints. In this example, an image processing algorithm can identify the same point in both images and calculate the distance triangulation. In another example, high frequency SONAR pulses are transmitted toward the object and the time it takes for the signal to reflect off the first object 560 and return to the UAV is used to determine the distance to the first object 560. In yet another example, a time-of-flight camera that includes an integrated light source and a camera is used to measure distance information for every pixel in the image by emitting a light pulse flash and calculating the time needed for the light to reach the first object 560 and reflect back to the camera. In yet another example, LIDAR is used to determine how long it takes for a laser pulse to travel from the sensor to the first object 560 and back and calculate the distance from the speed of light. In still another example, image processing algorithms are used to match sequential images taken by the same camera to determine distance to objects in the image.

The method of FIG. 5 also includes determining 506, by the geofence manager 501, whether the first location 562 of the detected first object 560 is within a geofence of an area. A geofence is a virtual perimeter around a real-world, physical, geographic area. The area around which the geofence is constructed or created may be any shape or size. The geofence may also be created in any number of ways including but not limited to a user drawing a perimeter line in a mapping application; a user providing coordinates for the perimeter; an application dynamically generating the perimeter around a fixed location or an object; a computer application storing the location(s) of the geofence in a computer readable storage medium. Determining 506, by the geofence manager 501, whether the first location 562 of the detected first object 560 is within a geofence of an area may be carried out by comparing the known location of the object to the locations or coordinates that define the geofence.

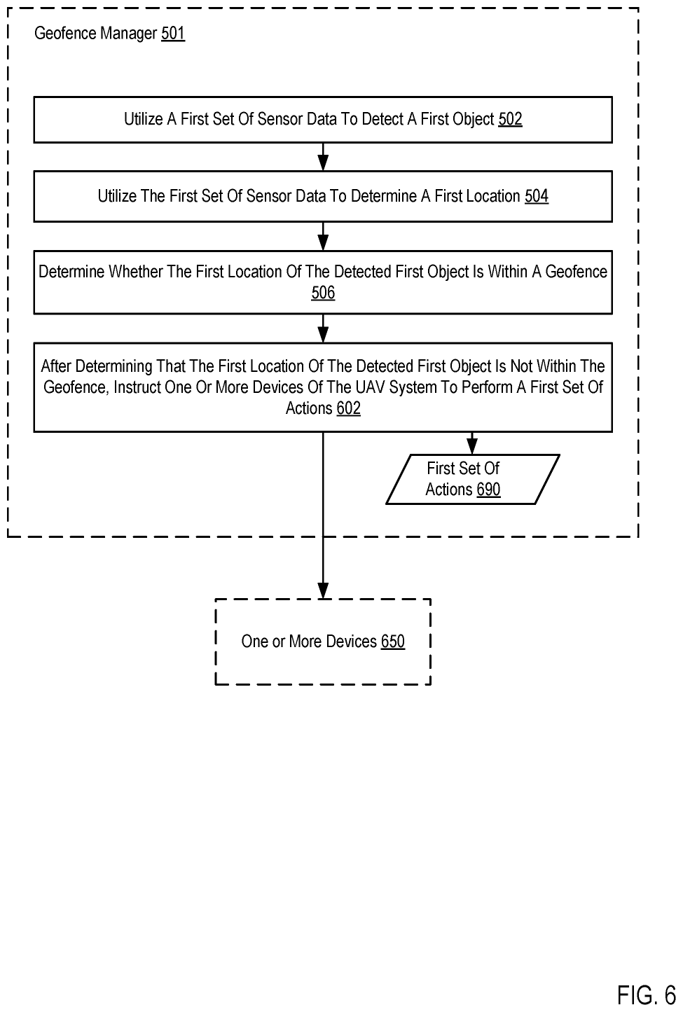

For further explanation, FIG. 6 sets forth a flow chart illustrating an exemplary method of geofence management with an unmanned aerial vehicle (UAV) in accordance with at least one embodiment of the present disclosure. The method of FIG. 6 is similar to the method of FIG. 5 in that the method of FIG. 6 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; and determining 506, by the geofence manager 501, whether the first location 562 of the detected first object 560 is within a geofence of an area.

However, the method of FIG. 6 also includes after determining that the first location 562 of the detected first object 560 is not within the geofence, instructing 602, by the geofence manager 501, one or more devices 650 of the UAV system to perform a first set 690 of actions. Devices of the UAV system may include UAVs; control devices; user devices; servers; data servers; and distributed computing systems. An action may be an operation, command, task, or behavior of a device of the UAV system. Examples of actions that a UAV may perform include but are not limited to activating speakers and playing a sound; turning-on a microphone and recording sound near the UAV; switching and executing operation modes (e.g., switching from a surveillance mode to a follow mode in which the UAV tracks the detected object); activating crowd control measures (e.g., light and sound devices); sending alerts, texts, and messages to a user device or some other device of the UAV system; activating cameras and capturing images or video; and others as will occur to those of skill in the art in view of the present disclosure. Examples of actions that a user device, server, distributed computing device may perform include but are not limited to sending an alert, a text, a message indicating an update regarding the location of the detected object relative to the geofence; displaying a map that displays the geofence and any relevant objects; displaying objects that violate a parameter or rule related to the geofence (e.g., a detected object is within the geofence; a detected object is outside the geofence). Instructing 602, by the geofence manager 501, one or more devices 650 of the UAV system to perform a first set 690 of actions may be carried out by executing an operation or command at the device; transmitting a message, command, instruction to the device; transmitting a message, command, or instruction to another device that relays the message, command, or instruction to the device.

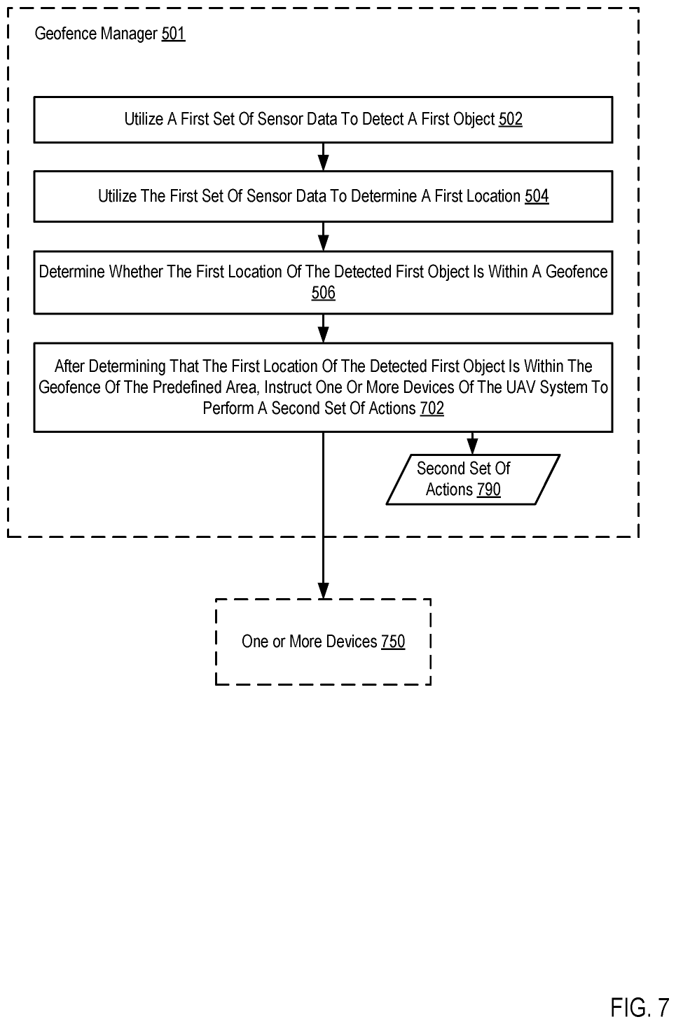

For further explanation, FIG. 7 sets forth a flow chart illustrating an exemplary method of geofence management with an unmanned aerial vehicle (UAV) in accordance with at least one embodiment of the present disclosure. The method of FIG. 7 is similar to the method of FIG. 5 in that the method of FIG. 7 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; and determining 506, by the geofence manager 501, whether the first location 562 of the detected first object 560 is within a geofence of an area.

However, the method of FIG. 7 includes after determining that the first location 562 of the detected first object 560 is within the geofence of the predefined area, instructing 702, by the geofence manager 501, one or more devices 750 of the UAV system to perform a second set 790 of actions. Devices of the UAV system may include UAVs; control devices; user devices; servers; data servers; and distributed computing systems. An action may be an operation, command, task, or behavior of a device of the UAV system. Examples of actions that a UAV may perform include but are not limited to activating speakers and playing a sound; turning-on a microphone and recording sound near the UAV; switching and executing operation modes (e.g., switching from a surveillance mode to a follow mode in which the UAV tracks the detected object); activating crowd control measures (e.g., light and sound devices); sending alerts, texts, and messages to a user device or some other device of the UAV system; activating cameras and capturing images or video; and others as will occur to those of skill in the art in view of the present disclosure. Examples of actions that a user device, server, distributed computing device may perform include but are not limited to sending an alert, text, message indicating an update regarding the location of the detected object relative to the geofence; displaying a map that displays the geofence and any relevant objects; displaying objects that violate a parameter or rule related to the geofence (e.g., a detected object is within the geofence; a detected object is outside the geofence). Instructing 702, by the geofence manager 501, one or more devices 750 of the UAV system to perform a second set 790 of actions may be carried out by executing an operation or command at the device; transmitting a message, command, instruction to the device; transmitting a message, command, or instruction to another device that relays the message, command, or instruction to the device.

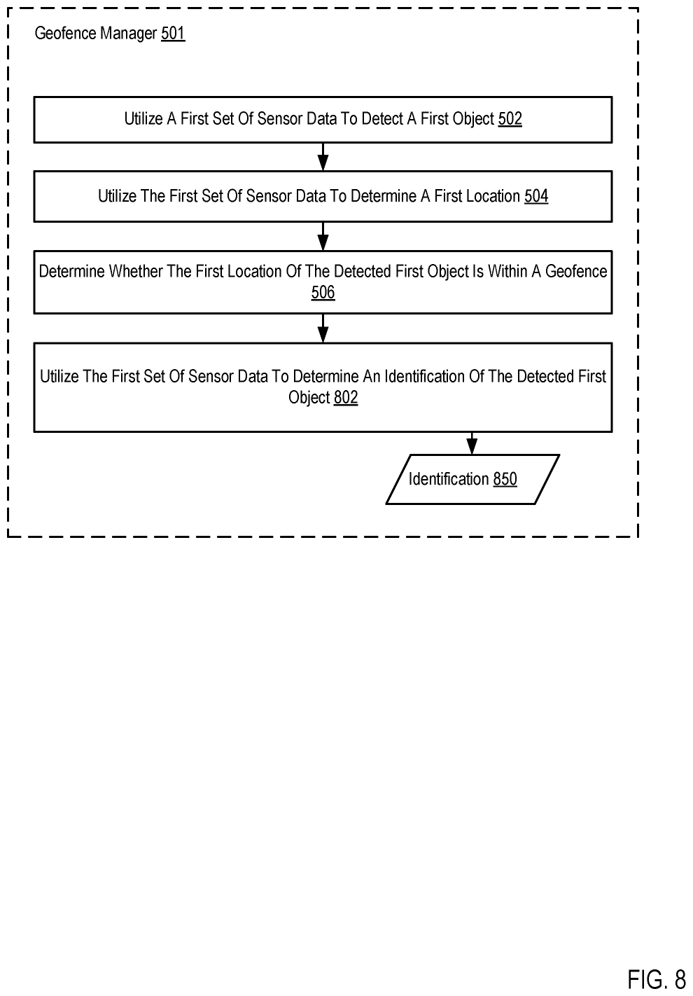

For further explanation, FIG. 8 sets forth a flow chart illustrating an exemplary method of geofence management with an unmanned aerial vehicle (UAV) in accordance with at least one embodiment of the present disclosure. The method of FIG. 8 is similar to the method of FIG. 5 in that the method of FIG. 8 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; and determining 506, by the geofence manager 501, whether the first location 562 of the detected first object 560 is within a geofence of an area.

The method of FIG. 8 includes utilizing 802, by the geofence manager 501, the first set 552 of sensor data to determine an identification 850 of the detected first object 560. As explained above, detecting and identifying an object may be carried out by using pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 560 within the image. Additionally, or alternatively, an image of the first object 560 may be generated from LIDAR, RADAR, or SONAR sensor data. For example, line scanning LIDAR may be employed to capture a representation of the first object 560 by illuminating the first object 560 with laser light and measuring the time the reflection of the light takes to return to the sensor. Differences in return times and light wavelengths can then be used to generate a three-dimensional representation of the target.

An identification 850 may include information and data indicating an image of the object; a classification of the object; a type of the object; or any other information that may be used to identify the object. For example, an identification associated with a vehicle may include one or more of the following types of information: color of the vehicle; designation of the vehicle as either being classified as an SUV, a car, or a truck; and length of the vehicle. As another example, an identification associated with a person may include one or more of the following types of information: hair color; eye color; face recognition information; and designation of the person as being classified as a child or an adult.

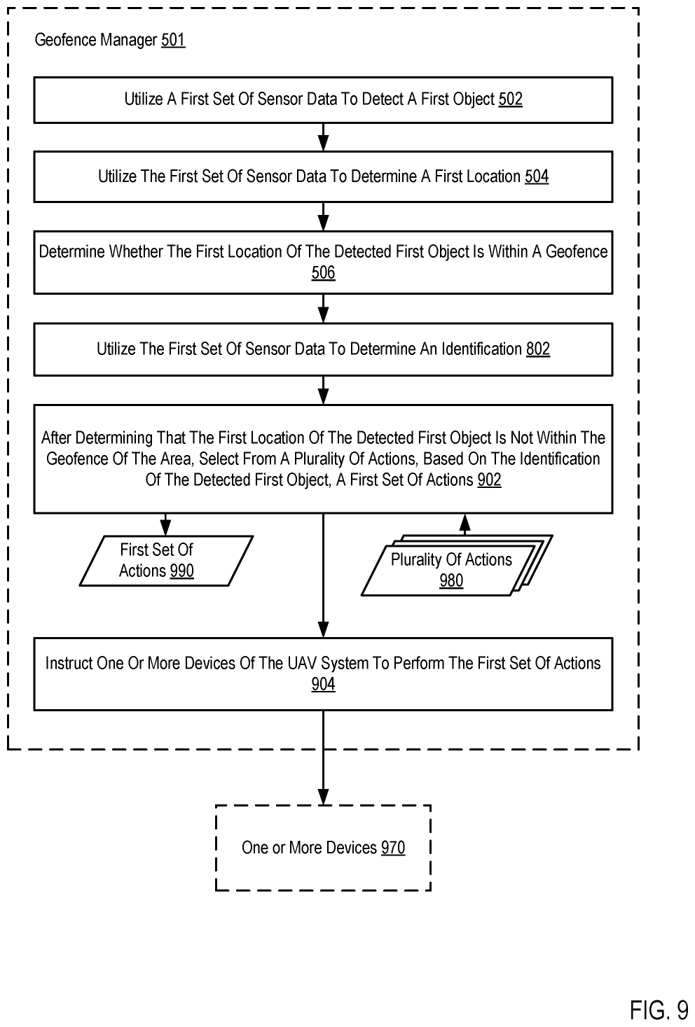

For further explanation, FIG. 9 sets forth a flow chart illustrating an exemplary method of geofence management with an unmanned aerial vehicle (UAV) in accordance with at least one embodiment of the present disclosure. The method of FIG. 9 is similar to the method of FIG. 8 in that the method of FIG. 9 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; determining 506, by the geofence manager 501, whether the first location 562 of the detected first object 560 is within a geofence of an area; and utilizing 802, by the geofence manager 501, the first set 552 of sensor data to determine an identification of the detected first object 560.

However, the method of FIG. 9 includes after determining that the first location 562 of the detected first object 560 is not within the geofence of the area, selecting 902 from a plurality 980 of actions, based on the identification 850 of the detected first object 560, by the geofence manager 501, a first set 990 of actions. Selecting 902 from a plurality 980 of actions, based on the identification 850 of the detected first object 560, by the geofence manager 501, a first set 990 of actions may be carried out by referring to an index or list that associates identifications of objects with one or more actions. In a particular embodiment, actions may be object specific. For example, determining that the identification of the detected first object is a child classification may result in the selection of one set of actions and determining that the identification of the detected first object is an adult classification may result in the selection of another set of actions. As another example, detecting a “known” or “cleared” object that is on a whitelist of known/cleared/approved objects may result in one set of actions and detecting that an unknown or uncleared object that is not on the whitelist may result in another set of actions. In this example, the geofence manager may have access to a database of known or precleared people, vehicles, or objects that can leave the geofence.

In addition, the method of FIG. 9 also includes instructing 904, by the geofence manager 501, one or more devices 970 of the UAV system to perform the first set 990 of actions. Instructing 904, by the geofence manager 501, one or more devices 970 of the UAV system to perform the first set 990 of actions may be carried out by executing an operation or command at the device; transmitting a message, command, instruction to the device; transmitting a message, command, or instruction to another device that relays the message, command, or instruction to the device.

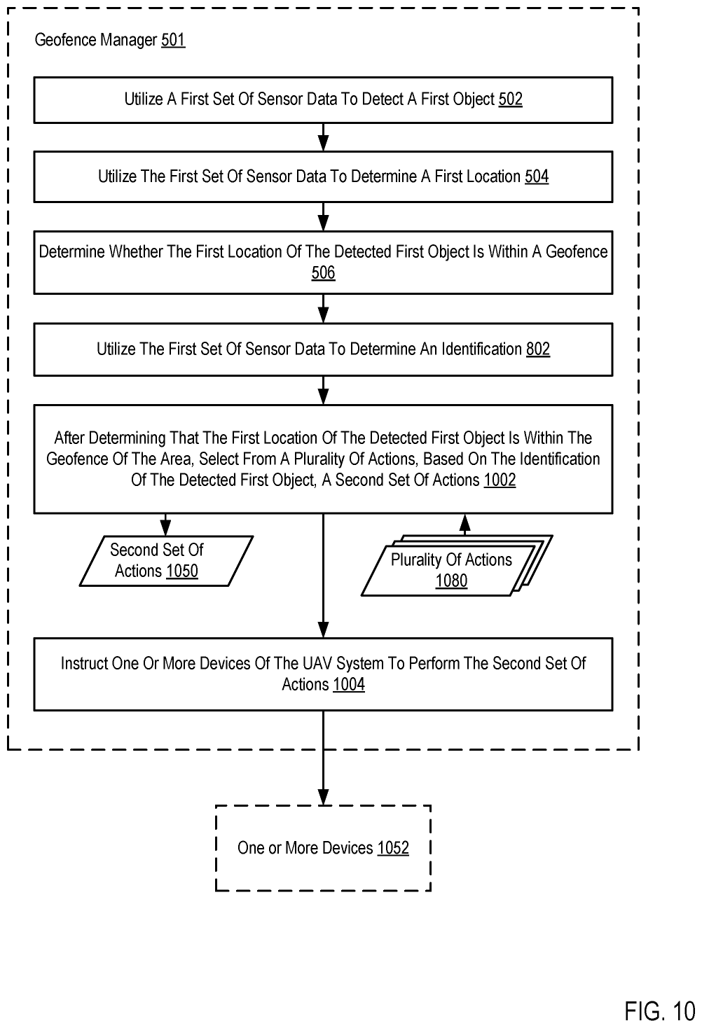

For further explanation, FIG. 10 sets forth a flow chart illustrating an exemplary method of geofence management with an unmanned aerial vehicle (UAV) in accordance with at least one embodiment of the present disclosure. The method of FIG. 10 is similar to the method of FIG. 8 in that the method of FIG. 10 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; determining 506, by the geofence manager 501, whether the first location 562 of the detected first object 560 is within a geofence of an area; and utilizing 802, by the geofence manager 501, the first set 552 of sensor data to determine an identification of the detected first object 560.

However, the method of FIG. 10 includes after determining that the first location 562 of the detected first object 560 is within the geofence of the area, selecting 1002 from a plurality 1080 of actions, based on the identification 850 of the detected first object 560, by the geofence manager 501, a second set 1050 of actions. Selecting 1002 from a plurality 1080 of actions, based on the identification 850 of the detected first object 560, by the geofence manager 501, a second set 1050 of actions may be carried out by referring to an index or list that associates identifications of objects with one or more actions. In a particular embodiment, actions may be object specific. For example, determining that the identification of the detected first object is a child classification may result in the selection of one set of actions and determining that the identification of the detected first object is an adult classification may result in the selection of another set of actions. As another example, detecting a “known” or “cleared” object that is on a whitelist of known/cleared/approved objects may result in one set of actions and detecting that an unknown or uncleared object that is not on the whitelist may result in another set of actions. In this example, the geofence manager may have access to a database of known or precleared people, vehicles, or objects that can leave the geofence.

In addition, the method of FIG. 10 also includes instructing 1004, by the geofence manager 501, one or more devices 1052 of the UAV system to perform the second set 1050 of actions. Instructing 1004, by the geofence manager 501, one or more devices 1052 of the UAV system to perform the second set 1050 of actions may be carried out by executing an operation or command at the device; transmitting a message, command, instruction to the device; transmitting a message, command, or instruction to another device that relays the message, command, or instruction to the device.

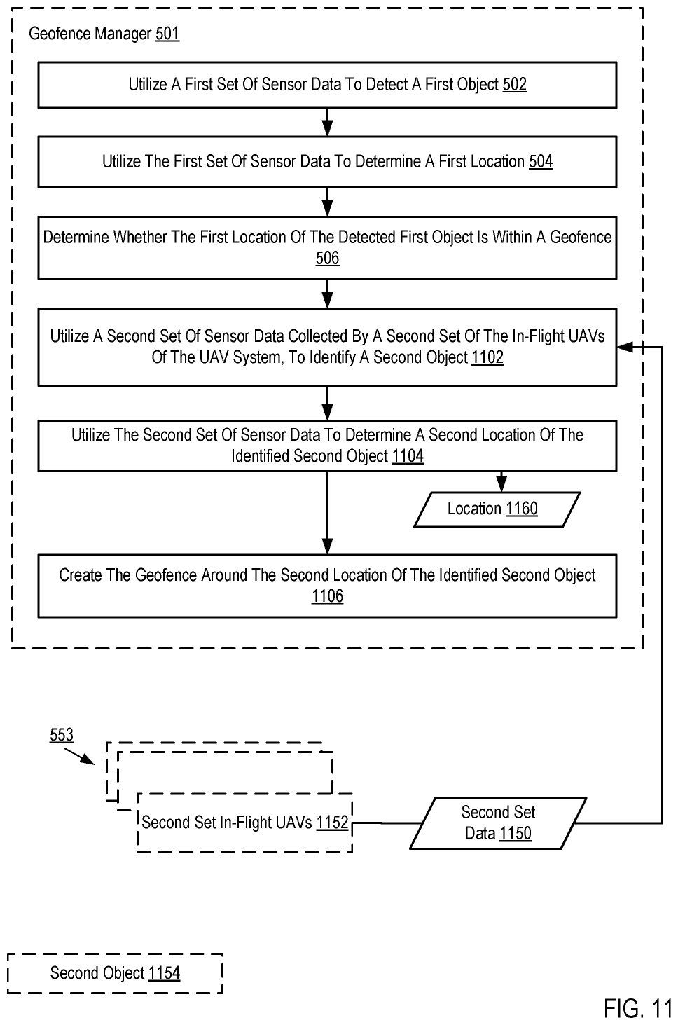

For further explanation, FIG. 11 sets forth a flow chart illustrating an exemplary method of geofence management with an unmanned aerial vehicle (UAV) in accordance with at least one embodiment of the present disclosure. The method of FIG. 11 is similar to the method of FIG. 5 in that the method of FIG. 11 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; and determining 506, by the geofence manager 501, whether the first location 562 of the detected first object 560 is within a geofence of an area.

However, the method of FIG. 11 includes utilizing 1102, by the geofence manager 501, a second set 1150 of sensor data collected by a second set 1152 of the in-flight UAVs 553 of the UAV system, to identify a second object 1154. In a particular embodiment, the second set of the in-flight UAVs may include the same in-flight UAVs as the first set. Alternatively, the second set of the in-flight UAVs may include at least some different in-flight UAVs as the first set. Also, the second set of sensor data may be include the same or different data than the first set of sensor data. Utilizing 1102, by the geofence manager 501, a second set 1150 of sensor data collected by a second set 1152 of the in-flight UAVs 553 of the UAV system, to identify a second object 1154 may be carried out by using various sensor data, such as cameras, LIDAR, SONAR, and RADAR; and applying pattern recognition techniques using machine vision to detect and identify the object.

In addition, the method of FIG. 11 also includes utilizing 1104, by the geofence manager 501, the second set 1150 of sensor data to determine a second location 1160 of the identified second object 1154. Utilizing 1104, by the geofence manager 501, the second set 1150 of sensor data to determine a second location 1160 of the identified second object 1154 may be carried out by analyzing the second set 1150 of sensor data to determine the second location 1160 of the second object 1154 based on the relationship of the second object 1154 to one or more known locations. In some examples, the location of the second object 1154 may be determined based on the location of the UAV (e.g., x-y or latitude-longitude location) determined from a GPS receiver, the compass orientation of the UAV, and the distance between the UAV and the second object 1154 as determined from, for example, LIDAR or SONAR data. The location of the second object 1154 may be determined using a variety of techniques based on knowing the location of the UAV from a GPS receiver.

The method of FIG. 11 also includes creating 1106, by the geofence manager 501, the geofence around the second location 1160 of the identified second object 1154. Creating 1106, by the geofence manager 501, the geofence around the second location 1160 of the identified second object 1154 may be carried out by calculating the locations of a perimeter in a radius around the second location; calculating the locations of a perimeter of a predetermined shape (e.g., a square, a rectangle); and calculating the locations of a perimeter of a computer-generated shape.

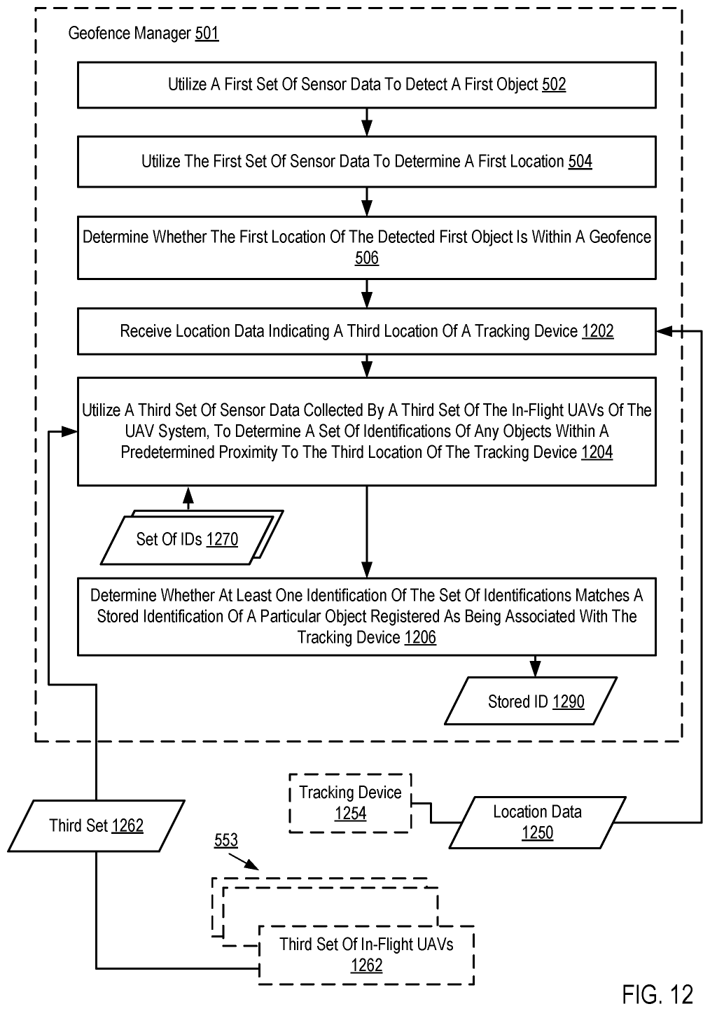

For further explanation, FIG. 12 sets forth a flow chart illustrating an exemplary method of geofence management with an unmanned aerial vehicle (UAV) in accordance with at least one embodiment of the present disclosure. The method of FIG. 12 is similar to the method of FIG. 5 in that the method of FIG. 12 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; and determining 506, by the geofence manager 501, whether the first location 562 of the detected first object 560 is within a geofence of an area.

However, the method of FIG. 12 includes receiving 1202, by the geofence manager 501, location data 1250 indicating a third location of a tracking device 1254. A tracking device may be any device that is capable of transmitting or broadcasting location data or be used to transmit a location. For example, GPS devices and satellite transceivers. Receiving 1202, by the geofence manager 501, location data 1250 indicating a third location of a tracking device 1254 may be carried out by directly receiving the location data; and receiving the location data from another device, such as a handheld device, a satellite, a cell tower, a wireless hub, and any other device that is capable of relaying information.

The method of FIG. 12 also includes utilizing 1204, by the geofence manager 501, a third set 1260 of sensor data collected by a third set 1262 of the in-flight UAVs 553 of the UAV system, to determine a set 1270 of identifications of any objects within a predetermined proximity to the third location of the tracking device 1254. As explained above, detecting an object may be carried out by using pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 560 within the image. Additionally, or alternatively, an image of the first object 560 may be generated from LIDAR, RADAR, or SONAR sensor data. For example, line scanning LIDAR may be employed to capture a representation of the first object 560 by illuminating the first object 560 with laser light and measuring the time the reflection of the light takes to return to the sensor. Differences in return times and light wavelengths can then be used to generate a three-dimensional representation of the target.

In addition, the method of FIG. 12 also includes determining 1206, by the geofence manager 501, whether at least one identification of the set 1270 of identifications matches a stored identification 1290 of a particular object registered as being associated with the tracking device 1254. A stored identification of a particular object registered as being associated with the tracking device may be a person, animal, vehicle, or other type of object. For example, a tracking device may be registered to a particular person have an identification (e.g., a picture of the person; a classification of the person; a type of object; etc). Determining 1206, by the geofence manager 501, whether at least one identification of the set 1270 of identifications matches a stored identification 1290 of a particular object registered as being associated with the tracking device 1254 may be carried out by comparing the information and data of each identification in the set of identification to the information and data of the stored identification.

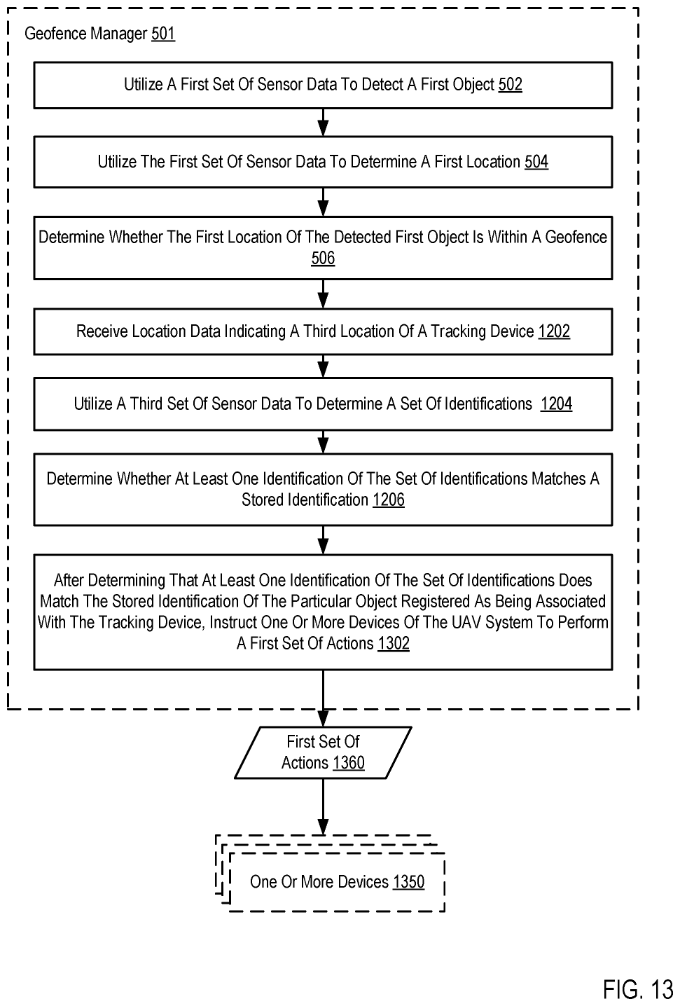

For further explanation, FIG. 13 sets forth a flow chart illustrating an exemplary method of geofence management with an unmanned aerial vehicle (UAV) in accordance with at least one embodiment of the present disclosure. The method of FIG. 13 is similar to the method of FIG. 12 in that the method of FIG. 13 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; determining 506, by the geofence manager 501, whether the first location 562 of the detected first object 560 is within a geofence of an area; receiving 1202, by the geofence manager 501, location data 1250 indicating a third location of a tracking device 1254; utilizing 1204, by the geofence manager 501, a third set 1260 of sensor data collected by a third set 1262 of the in-flight UAVs 553 of the UAV system, to determine a set 1270 of identifications of any objects within a predetermined proximity to the third location of the tracking device 1254; and determining 1206, by the geofence manager 501, whether at least one identification of the set 1270 of identifications matches a stored identification 1290 of a particular object registered as being associated with the tracking device 1254.

However, the method of FIG. 13 also includes after determining that at least one identification of the set 1270 of identifications does match the stored identification 1290 of the particular object registered as being associated with the tracking device 1254, instructing 1302, by the geofence manager 501, one or more devices 1350 of the UAV system to perform a first set 1360 of actions. Devices of the UAV system may include UAVs; control devices; user devices; servers; data servers; and distributed computing systems. An action may be an operation, command, task, or behavior of a device of the UAV system. Examples of actions that a UAV may perform include but are not limited to activating speakers and playing a sound; turning-on a microphone and recording sound near the UAV; switching and executing operation modes (e.g., switching from a surveillance mode to a follow mode in which the UAV tracks the detected object); activating crowd control measures (e.g., light and sound devices); sending messages to a user device or some other device of the UAV system; activating cameras and capturing images or video; and others as will occur to those of skill in the art in view of the present disclosure. Examples of actions that a user device, server, distributed computing device may perform include but are not limited to sending an alert, text, message indicating an update regarding the location of the detected object relative to the geofence; displaying a map that displays the geofence and any relevant objects; displaying objects that violate a parameter or rule related to the geofence (e.g., a detected object is within the geofence; a detected object is outside the geofence). Instructing 1302, by the geofence manager 501, one or more devices 1350 of the UAV system to perform a first set 1360 of actions may be carried out by executing an operation or command at the device; transmitting a message, command, instruction to the device; transmitting a message, command, or instruction to another device that relays the message, command, or instruction to the device.

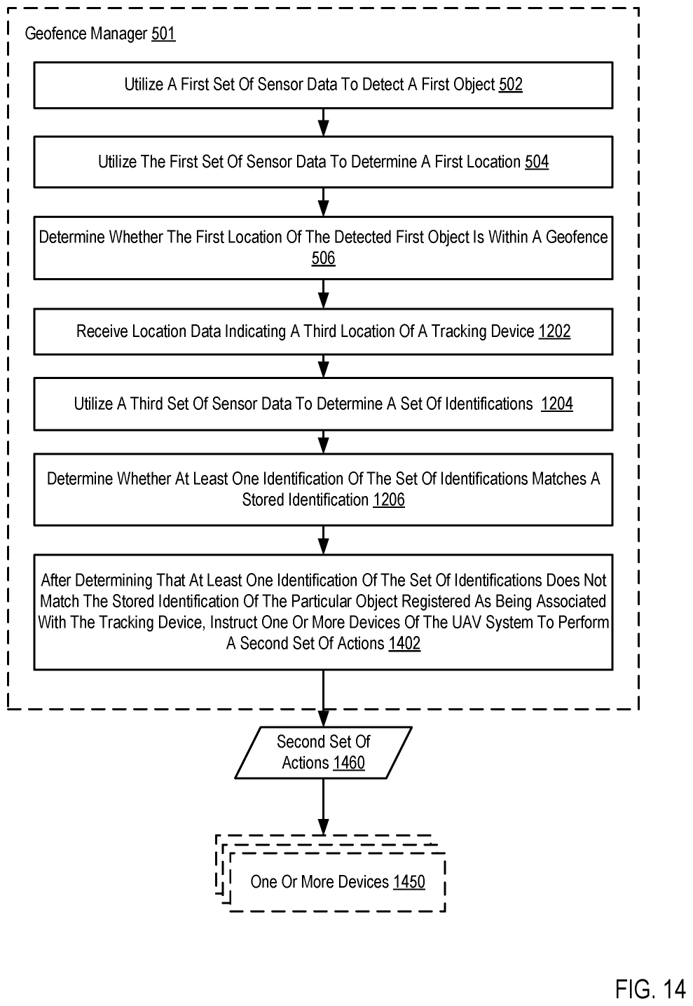

For further explanation, FIG. 14 sets forth a flow chart illustrating an exemplary method of geofence management with an unmanned aerial vehicle (UAV) in accordance with at least one embodiment of the present disclosure. The method of FIG. 14 is similar to the method of FIG. 12 in that the method of FIG. 14 also includes utilizing 502, by a geofence manager 501, a first set 550 of sensor data collected by a first set 552 of the in-flight UAVs 553 of the UAV system to detect a first object 560; utilizing 504, by the geofence manager 501, the first set 550 of sensor data to determine a first location 562 of the detected first object 560; determining 506, by the geofence manager 501, whether the first location 562 of the detected first object 560 is within a geofence of an area; receiving 1202, by the geofence manager 501, location data 1250 indicating a third location of a tracking device 1254; utilizing 1204, by the geofence manager 501, a third set 1260 of sensor data collected by a third set 1262 of the in-flight UAVs 553 of the UAV system, to determine a set 1270 of identifications of any objects within a predetermined proximity to the third location of the tracking device 1254; and determining 1206, by the geofence manager 501, whether at least one identification of the set 1270 of identifications matches a stored identification 1290 of a particular object registered as being associated with the tracking device 1254.

The method of FIG. 14 also includes after determining that at least one identification of the set 1270 of identifications does not match the stored identification 1290 of the particular object registered as being associated with the tracking device 1254, instructing 1402, by the geofence manager 501, one or more devices 1450 of the UAV system to perform a second set 1460 of actions. Devices of the UAV system may include UAVs; control devices; user devices; servers; data servers; and distributed computing systems. An action may be an operation, command, task, or behavior of a device of the UAV system. Examples of actions that a UAV may perform include but are not limited to activating speakers and playing a sound; turning-on a microphone and recording sound near the UAV; switching and executing operation modes (e.g., switching from a surveillance mode to a follow mode in which the UAV tracks the detected object); activating crowd control measures (e.g., light and sound devices); sending messages to a user device or some other device of the UAV system; activating cameras and capturing images or video; and others as will occur to those of skill in the art in view of the present disclosure. Examples of actions that a user device, server, distributed computing device may perform include but are not limited to sending an alert, text, message indicating an update regarding the location of the detected object relative to the geofence; displaying a map that displays the geofence and any relevant objects; displaying objects that violate a parameter or rule related to the geofence (e.g., a detected object is within the geofence; a detected object is outside the geofence). Instructing 1402, by the geofence manager 501, one or more devices 1450 of the UAV system to perform a second set 1460 of actions may be carried out by executing an operation or command at the device; transmitting a message, command, instruction to the device; transmitting a message, command, or instruction to another device that relays the message, command, or instruction to the device.

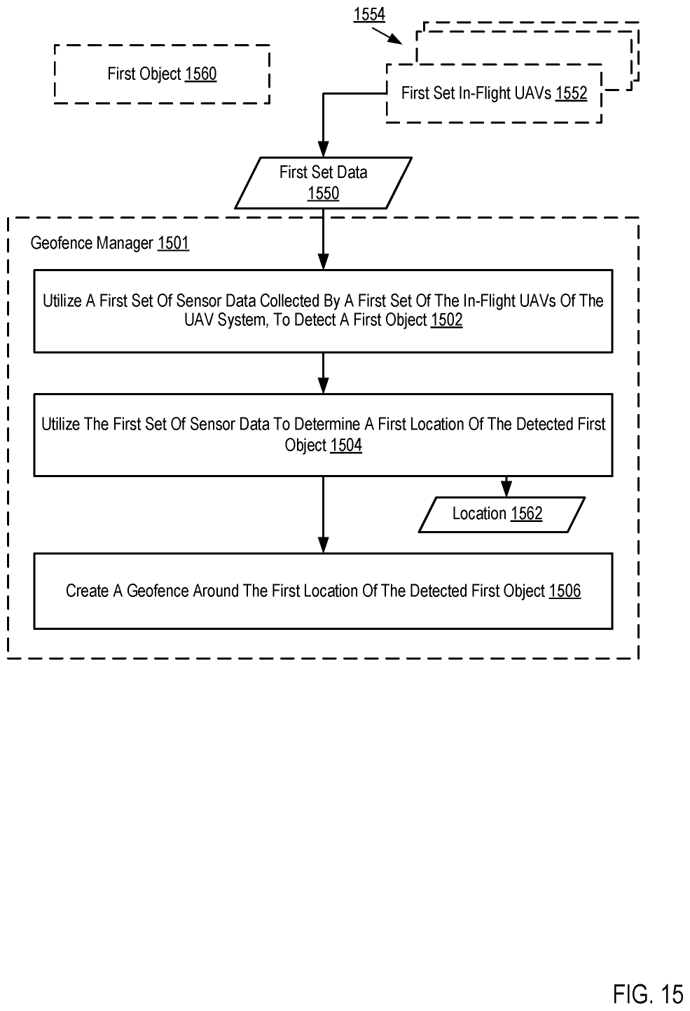

For further explanation, FIG. 15 sets forth a flow chart illustrating an exemplary method of geofence management with an unmanned aerial vehicle (UAV) in accordance with at least one embodiment of the present disclosure. A geofence manager 501 may include a set of computer program instructions that are executed by a processor. For example, the geofence manager 501 of FIG. 5 may be the geofence manager 139 of FIGS. 1 and 2 or the geofence manager 145 of FIG. 1. The method of FIG. 15 includes utilizing 1502, by a geofence manager 1501, a first set 1550 of sensor data collected by a first set 1552 of the in-flight UAVs 1554 of the UAV system, to detect a first object 1560.

The sensor data may include data collected from one or more sensors of a UAV (e.g., the UAV 102 of FIG. 1) such as gyroscopes; accelerometers; thermometers; inertial measurement sensors (magnetometer); barometers; GPS sensors; distance sensors (e.g., sensors based on radio detection and ranging; magnetic-field change sensing; sonar-pulse distance sensing (ultrasonic); time of flight (ToF) sensors (range imaging); light-pulse distance sensing (laser); SONAR, RADAR, and LIDAR); optical still or video cameras; monocular or stereo vision cameras; anemometers to measure wind speed and direction; heat detection devices (e.g., infrared sensors, thermal imaging vision cameras, etc); and chemical sensors for the detection of chemicals present in the environment). The sensor data is collected by the UAV and utilized by the UAV for object detection and object classification, or the collected sensor data is streamed to a remote device such as a UAV user device (e.g., the user device 120 of FIG. 1) or a server (e.g., the server 140 of FIG. 1) for object detection and object identification.

In some embodiments, utilizing 1502, by a geofence manager 1501, a first set 1550 of sensor data collected by a first set 1552 of the in-flight UAVs 1554 of the UAV system, to detect a first object 1560 is carried out through pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and identification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 1560 within the image. Additionally or alternatively, an image of the first object 1560 may be generated from LIDAR, RADAR, or SONAR sensor data. For example, line scanning LIDAR may be employed to capture a representation of the first object 1560 by illuminating the first object 1560 with laser light and measuring the time the reflection of the light takes to return to the sensor. Differences in return times and light wavelengths can then be used to generate a three-dimensional representation of the target.

A variety of sensors may be used to obtain imagery of the detected object 560. In fact, given the variety of sensors equipped on a UAV, sensor data from these sensors may be combined to further enhance an image of the first object 1560. For example, an image from a camera may be combined with imagery generated from LIDAR sensor data and imagery generated from SONAR sensor data. The imagery generated from the sensor data of each sensor may be transformed into the same coordinate system (and with the same scale and perspective) such that the images may be overlaid. These image layers may then be flattened into a single image with enhanced features that would not have been detected based on any single sensor. This flattened image may include enhanced features that provide better image resolution for feature detection and extraction.

Feature detection and extraction techniques may be applied to the image to obtain a set of features useful in identifying the first object 1560. In some examples, convolution neural networks, support vector machines, and/or deep learning methods are used to extract features of the object and/or identify the object. For example, object recognition techniques such as region-based convolutional neural networks (R-CNN) or You Only Look Once (YOLO) may be useful in identifying, based on the sensor data collected by the in-flight UAVs, a classification of a detected object. In some examples, template-based image matching may be used in which a set of sample points of the extracted features are compared to image templates for object identification. Other object recognition and machine vision techniques, such as optical character recognition (OCR) and shape recognition technology (SRT) may be useful in object recognition, classification, and identification. Readers will appreciate that an object may be part of a scene of objects, such that the scene provides context for object identification. A variety of other machine vision and object recognition, classification, and identification techniques, as will occur to those of skill in the art, may be utilized to identify an object type of a detected object.

In some examples, utilizing 1502, by a geofence manager 1501, a first set 1550 of sensor data collected by a first set 1552 of the in-flight UAVs 1554 of the UAV system, to detect a first object 1560 includes identifying object types that are particularly relevant to UAV operation and UAV missions. For example, exterior artifacts such as structures and vehicles are more likely to be relevant to UAV operation and UAV missions than interior artifacts such as furniture or appliances. As such, the geofence manager 1501 may employ a particular set of object classifications for object or object type identification. For example, object classifications may include person, animal, vehicle, structure, liquid, vegetation, smoke, fire, and so on, that may be encountered during UAV flight. In some examples, subtypes or particular instances of an object classification, including particular characteristics of the object, may be identified. For example, the object could be a particular person or a particular vehicle. In such instances, the object may be identified using techniques such as facial recognition or other identification techniques. In other examples, the object to be detected can be a set of persons, such as persons having a particular characteristic. In still other examples of subtypes of object classifications, a body of liquid may be further differentiated as a lake, a river, etc.; a structure may be differentiated as a building, a communications tower; etc.; an animal by be differentiated by species, etc.

In some examples, the object classification is identified based on an association with another object. For example, the geofence manager 1501 may recognize a tall structure and identify the structure as a high-tension power line structure based on identified power lines attached to it. In another example, a characteristic may include patterns for recognition such as a bar code or quick response (QR) code, an object temperature, a movement characteristic such as smooth or intermittent, a gait style, object emissions, sound patterns, or other characteristics. Identifying the object type of a particular object may rely upon a plurality of sensors. For example, the sensor data may include information from a camera for a visual identification, a microphone for audio detection, a GPS system for identifying location, and/or a thermal sensor for identifying a temperature.

In a particular embodiment, utilizing 1502, by a geofence manager 1501, a first set 1550 of sensor data collected by a first set 1552 of the in-flight UAVs 1554 of the UAV system, to detect a first object 1560 includes identifying the classification of the detected object in dependence upon the sensor data and one or more object models. In some examples, identifying the classification of the detected object in dependence upon the sensor data and one or more object models is carried out by the geofence manager 1501 loading one or more object models and comparing the object pattern recognized from the sensor data. For example, an artificial neural network may be trained on a set of training images for a particular object to generate an object model for that object. The object model may include a set of features represented by shape context vectors. Once features have been extracted from the object pattern recognized from the image(s) generated from the sensor data, the extracted features may be compared to the set of features for a candidate object model. This comparison may be scored based on the matching of extracted features of the detected object and features of the object model. The process is then repeated for other candidate object models. Based on the scores, a candidate object model may be selected as the matching object model upon which the detected object is classified.

To reduce the amount of computation required to compare the detected object to object models, the entire set of object models may be filtered to produce the set of candidate object models. Filtering may be applied based on characteristics of the detected object or scene, conditions present in the UAV, one or more UAV missions, or combinations thereof. As one simplified example, based on the altitude of the UAV and the camera angle, it may be easily determined that the scene of the image that includes the detected object is a skyscape. This precludes object models that are ground-based such a people, animals, vehicles. Based on a mission of collision avoidance, the set of candidate models may be narrowed based on the altitude of the UAV or the detected object, which may preclude object models for houses and retail stores and small office buildings. Based on the location of the UAV and the pastoral nature of the captured scene (e.g., a rural location, sparsely detected structures, observable greenery), the set of candidate object models may be filtered to exclude an office building, apartment building, or a construction crane. Ultimately, the set of candidate models may be, for example: aircraft, cell tower, or radio tower. If the detected object is actually a radio tower, the comparison of the extracted features of the detected object to the radio tower object model will score high than the comparisons based on the aircraft object model and the cell tower object model.

In some examples, the object models loaded by the geofence manager 501 may be specific to the UAV mission. For example, when the UAV mission is to find people, object models for people are loaded by the geofence manager. When the UAV mission is to find cows, cow object models are loaded by the geofence manager. In this way, the number of candidate object models may be further filtered and thus the number of comparisons may be reduced, thereby conserving computation resources, and expediting a match result.

In some examples where the geofence manager 1501 is implemented in the UAV (i.e., the geofence manager 113 of the UAV 102 in FIG. 1), the UAV may be preloaded with a set of object models in the memory of the UAV (e.g., the memory 106 of FIG. 1) prior to executing a mission. For example, the UAV may be preloaded with object models that are specific to the UAV's mission. The UAV may also receive object models in-flight that are transmitted from a remote device (e.g., the user device 120 or the server 140 of FIG. 1).

In some examples where the geofence manager 1501 is implemented in a user device (e.g., the geofence manager 139 of the user device 120 of FIG. 1), the user device may store a set of object models locally in the memory of the user device (e.g., the memory 124 of FIG. 1) prior to operating a UAV mission or the user device may receive object models that are transmitted from a remote device (e.g., the server 140 of FIG. 1) while the UAV is in-flight.

In some examples where the geofence manager 1501 is implemented in a server (e.g., the geofence manager 145 of the server 140 of FIG. 1), the server may store all object models such that the server acts as a central repository for object models. The server may provide one or more object models from the entire set of object models, where the one or more object models are used in carrying out the UAV mission. In some examples, a standard set of object models may be provided for typical UAV flight operation (e.g., UAV navigation, collision avoidance, and route planning), while a specialized set of object models may be provided for a particular UAV mission. In some examples, a set of object models are stored on the same server as a map server that includes an airspace awareness map database.

In addition, the method of FIG. 15 also includes utilizing 1504, by the geofence manager 1501, the first set 1550 of sensor data to determine a first location 1562 of the detected first object 1560. Utilizing 1504, by the geofence manager 1501, the first set 1550 of sensor data to determine a first location 1562 of the detected first object 1560 may be carried out by analyzing sensor data to determine a location 1562 of an object 1560 based on the relationship of the first object 1560 to one or more known locations. In some examples, the location of the first object 1560 may be determined based on the location of the UAV (e.g., x-y or latitude-longitude location) determined from a GPS receiver, the compass orientation of the UAV, and the distance between the UAV and the first object 1560 as determined from, for example, LIDAR or SONAR data. The location of the first object 1560 may be determined using a variety of techniques based on knowing the location of the UAV from a GPS receiver.

To determine the location of the first object 1560, a number of techniques may be employed to determine the distance between the UAV and the first object 1560 based on the sensor data. In one example, stereo cameras are used to capture two images of the object from different viewpoints. In this example, an image processing algorithm can identify the same point in both images and calculate the distance triangulation. In another example, high frequency SONAR pulses are transmitted toward the object and the time it takes for the signal to reflect off the first object 1560 and return to the UAV is used to determine the distance to the first object 1560. In yet another example, a time-of-flight camera that includes an integrated light source and a camera is used to measure distance information for every pixel in the image by emitting a light pulse flash and calculating the time needed for the light to reach the first object 1560 and reflect back to the camera. In yet another example, LIDAR is used to determine how long it takes for a laser pulse to travel from the sensor to the first object 1560 and back and calculate the distance from the speed of light. In still another example, image processing algorithms are used to match sequential images taken by the same camera to determine distance to objects in the image.

The method of FIG. 15 also includes creating 1506, by the geofence manager 1501, a geofence around the first location 1562 of the detected first object 1560. A geofence is a virtual perimeter around a real-world, physical, geographic area. The area around which the geofence is constructed or created may be any shape or size. The geofence may also be created in any number of ways including but not limited to a user drawing a perimeter line in a mapping application; a user providing coordinates for the perimeter; an application dynamically generating the perimeter around a fixed location or an object. Creating 1506, by the geofence manager 1501, a geofence around the first location 1562 of the detected first object 1560 may be carried out by calculating the locations of a perimeter in a radius around the second location; calculating the locations of a perimeter of a predetermined shape (e.g., a square, a rectangle); and calculating the locations of a perimeter of a computer-generated shape.

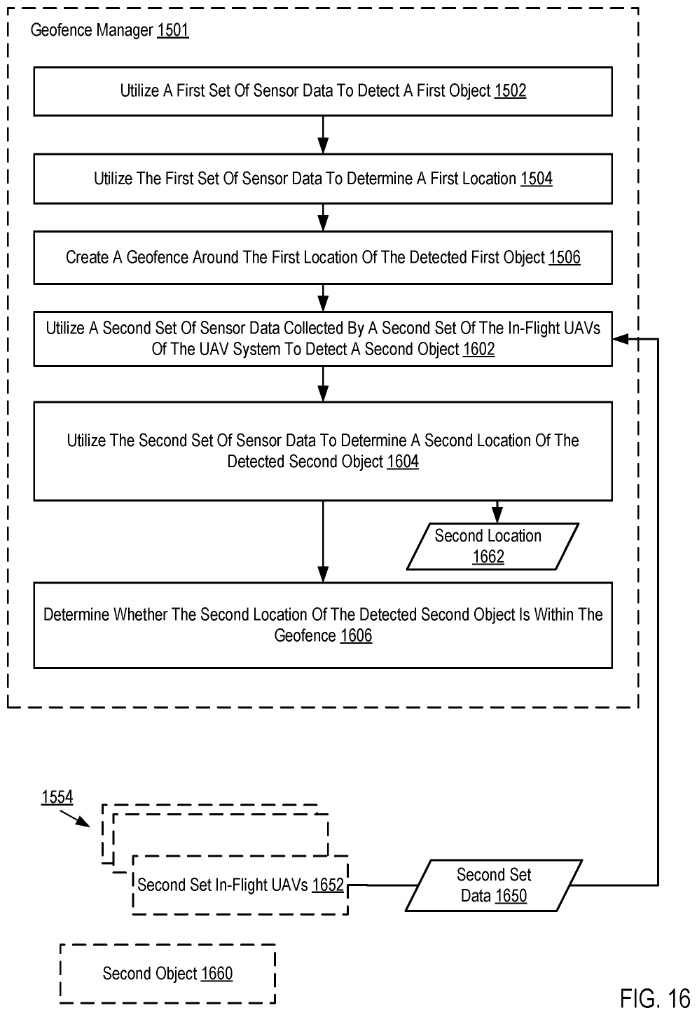

For further explanation, FIG. 16 sets forth a flow chart illustrating an exemplary method of geofence management with an unmanned aerial vehicle (UAV) in accordance with at least one embodiment of the present disclosure. The method of FIG. 16 is similar to the method of FIG. 15 in that the method of FIG. 16 also includes utilizing 1502, by a geofence manager 1501, a first set 1550 of sensor data collected by a first set 1552 of the in-flight UAVs 1554 of the UAV system, to detect a first object 1560; utilizing 1504, by the geofence manager 1501, the first set 1550 of sensor data to determine a first location 1562 of the detected first object 1560; and creating 1506, by the geofence manager 1501, a geofence around the first location 1562 of the detected first object 1560.

However, the method of FIG. 16 also includes utilizing 1602, by the geofence manager 1501, a second set 1650 of sensor data collected by a second set 1652 of the in-flight UAVs 1554 of the UAV system to detect a second object 1660. Utilizing 1602, by the geofence manager 1501, a second set 1650 of sensor data collected by a second set 1652 of the in-flight UAVs 1554 of the UAV system to detect a second object 1660 may be carried out by pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 560 within the image. Additionally, or alternatively, an image of the first object 1560 may be generated from LIDAR, RADAR, or SONAR sensor data. For example, line scanning LIDAR may be employed to capture a representation of the first object 1560 by illuminating the first object 560 with laser light and measuring the time the reflection of the light takes to return to the sensor. Differences in return times and light wavelengths can then be used to generate a three-dimensional representation of the target.

In addition, the method of FIG. 16 also includes utilizing 1604, by the geofence manager 1501, the second set 1650 of sensor data to determine a second location 1662 of the detected second object 1660. Utilizing 1604, by the geofence manager 1501, the second set 1650 of sensor data to determine a second location 1662 of the detected second object 1660 may be carried out by analyzing sensor data to determine a location of an object based on the relationship of the object to one or more known locations. In some examples, the location of the second object may be determined based on the location of the UAV (e.g., x-y or latitude-longitude location) determined from a GPS receiver, the compass orientation of the UAV, and the distance between the UAV and the second object as determined from, for example, LIDAR or SONAR data. The location of the second object may be determined using a variety of techniques based on knowing the location of the UAV from a GPS receiver.

The method of FIG. 16 also includes determining 1606, by the geofence manager 1501, whether the second location 1662 of the detected second object 1660 is within the geofence. Determining 1606, by the geofence manager 1501, whether the second location 1662 of the detected second object 1660 is within the geofence may be carried out by comparing the known location of the object to the location(s) or coordinates that define the geofence.

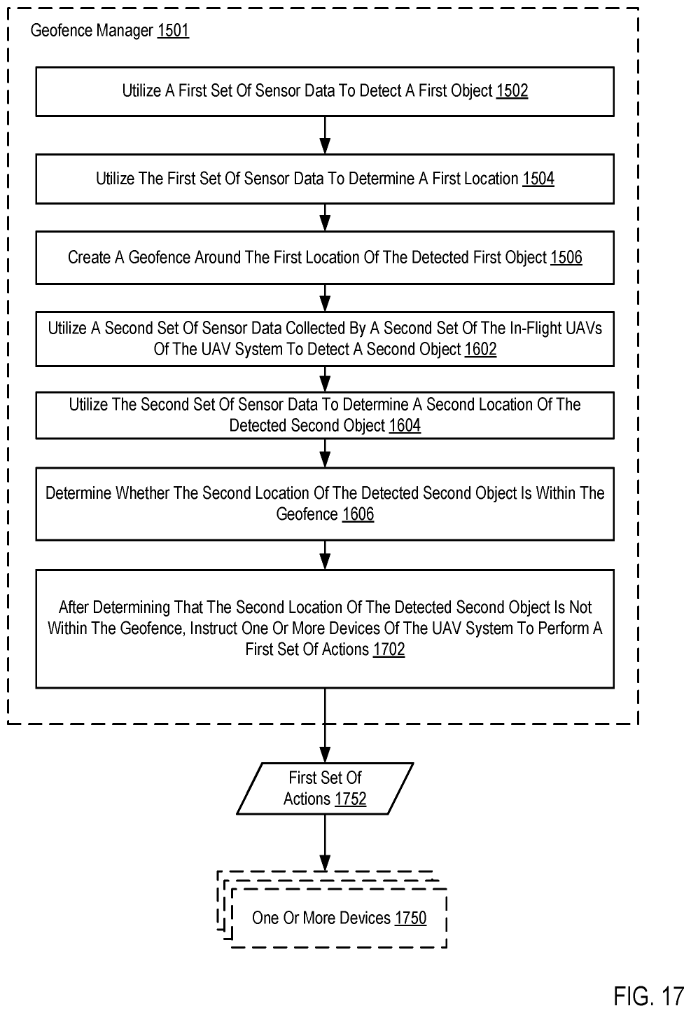

For further explanation, FIG. 17 sets forth a flow chart illustrating an exemplary method of geofence management with an unmanned aerial vehicle (UAV) in accordance with at least one embodiment of the present disclosure. The method of FIG. 17 is similar to the method of FIG. 16 in that the method of FIG. 17 also includes utilizing 1502, by a geofence manager 1501, a first set 1550 of sensor data collected by a first set 1552 of the in-flight UAVs 1554 of the UAV system, to detect a first object 1560; utilizing 1504, by the geofence manager 1501, the first set 1550 of sensor data to determine a first location 1562 of the detected first object 1560; creating 1506, by the geofence manager 1501, a geofence around the first location 1562 of the detected first object 1560; utilizing 1602, by the geofence manager 1501, a second set 1650 of sensor data collected by a second set 1652 of the in-flight UAVs 1554 of the UAV system to detect a second object 1660; utilizing 1604, by the geofence manager 1501, the second set 1650 of sensor data to determine a second location 1662 of the detected second object 1660; and determining 1606, by the geofence manager 1501, whether the second location 1662 of the detected second object 1660 is within the geofence.

The method of FIG. 17 includes after determining that the second location 1662 of the detected second object 1660 is not within the geofence, instructing 1702, by the geofence manager 1501, one or more devices 1750 of the UAV system to perform a first set 1752 of actions. Devices of the UAV system may include UAVs; control devices; user devices; servers; data servers; and distributed computing systems. An action may be an operation, command, task, or behavior of a device of the UAV system. Examples of actions that a UAV may perform include but are not limited to activating speakers and playing a sound; turning-on a microphone and recording sound near the UAV; switching and executing operation modes (e.g., switching from a surveillance mode to a follow mode in which the UAV tracks the detected object); activating crowd control measures (e.g., light and sound devices); sending alerts, texts, and messages to a user device or some other device of the UAV system; activating cameras and capturing images or video; and others as will occur to those of skill in the art in view of the present disclosure. Examples of actions that a user device, server, distributed computing device may perform include but are not limited to sending an alert, a text, a message indicating an update regarding the location of the detected object relative to the geofence; displaying a map that displays the geofence and any relevant objects; displaying objects that violate a parameter or rule related to the geofence (e.g., a detected object is within the geofence; a detected object is outside the geofence). Instructing 1702, by the geofence manager 1501, one or more devices 1750 of the UAV system to perform a first set 1752 of actions may be carried out by executing an operation or command at the device; transmitting a message, command, instruction to the device; transmitting a message, command, or instruction to another device that relays the message, command, or instruction to the device.

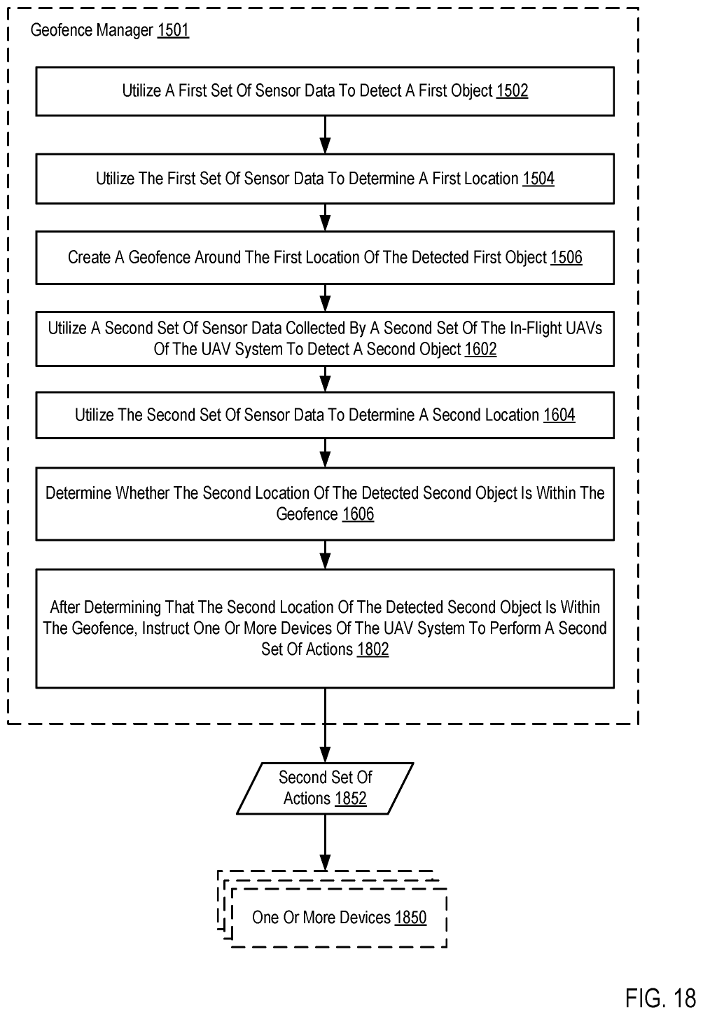

For further explanation, FIG. 18 sets forth a flow chart illustrating an exemplary method of geofence management with an unmanned aerial vehicle (UAV) in accordance with at least one embodiment of the present disclosure. The method of FIG. 18 is similar to the method of FIG. 16 in that the method of FIG. 18 also includes utilizing 1502, by a geofence manager 1501, a first set 1550 of sensor data collected by a first set 1552 of the in-flight UAVs 1554 of the UAV system, to detect a first object 1560; utilizing 1504, by the geofence manager 1501, the first set 1550 of sensor data to determine a first location 1562 of the detected first object 1560; creating 1506, by the geofence manager 1501, a geofence around the first location 1562 of the detected first object 1560; utilizing 1602, by the geofence manager 1501, a second set 1650 of sensor data collected by a second set 1652 of the in-flight UAVs 1554 of the UAV system to detect a second object 1660; utilizing 1604, by the geofence manager 1501, the second set 1650 of sensor data to determine a second location 1662 of the detected second object 1660; and determining 1606, by the geofence manager 1501, whether the second location 1662 of the detected second object 1660 is within the geofence.

The method of FIG. 18 includes after determining that the second location 1662 of the detected second object 1660 is within the geofence, instructing 1802, by the geofence manager 1501, one or more devices 1850 of the UAV system to perform a second set 1852 of actions. Devices of the UAV system may include UAVs; control devices; user devices; servers; data servers; and distributed computing systems. An action may be an operation, command, task, or behavior of a device of the UAV system. Examples of actions that a UAV may perform include but are not limited to activating speakers and playing a sound; turning-on a microphone and recording sound near the UAV; switching and executing operation modes (e.g., switching from a surveillance mode to a follow mode in which the UAV tracks the detected object); activating crowd control measures (e.g., light and sound devices); sending alerts, texts, and messages to a user device or some other device of the UAV system; activating cameras and capturing images or video; and others as will occur to those of skill in the art in view of the present disclosure. Examples of actions that a user device, server, distributed computing device may perform include but are not limited to sending an alert, a text, a message indicating an update regarding the location of the detected object relative to the geofence; displaying a map that displays the geofence and any relevant objects; displaying objects that violate a parameter or rule related to the geofence (e.g., a detected object is within the geofence; a detected object is outside the geofence). Instructing 1802, by the geofence manager 1501, one or more devices 1850 of the UAV system to perform a second set 1852 of actions may be carried out by executing an operation or command at the device; transmitting a message, command, instruction to the device; transmitting a message, command, or instruction to another device that relays the message, command, or instruction to the device.

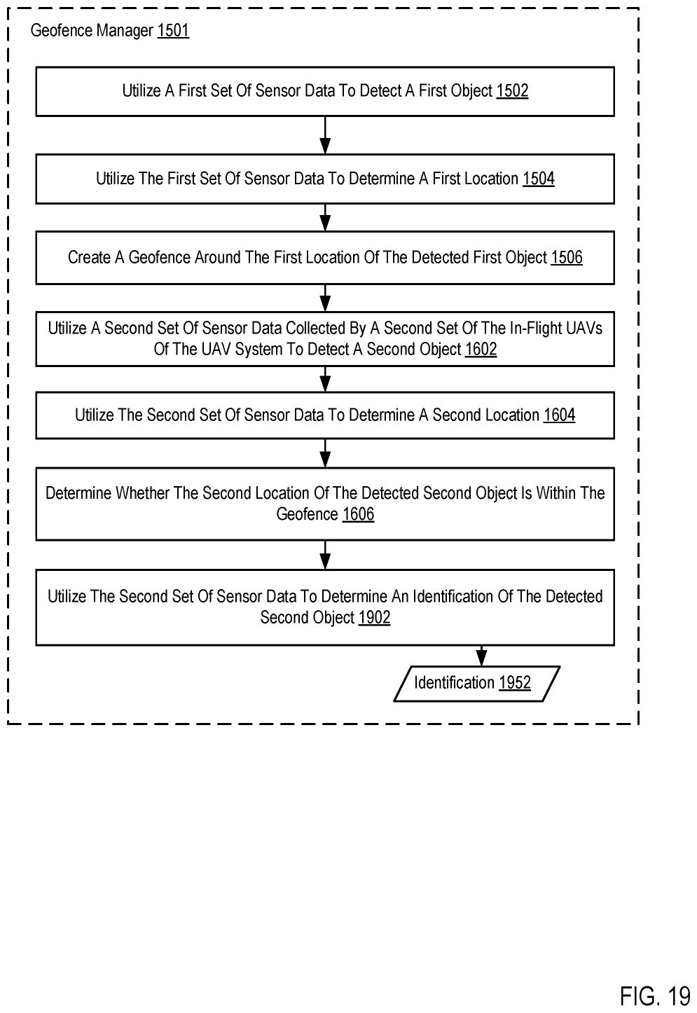

For further explanation, FIG. 19 sets forth a flow chart illustrating an exemplary method of geofence management with an unmanned aerial vehicle (UAV) in accordance with at least one embodiment of the present disclosure. The method of FIG. 19 is similar to the method of FIG. 16 in that the method of FIG. 19 also includes utilizing 1502, by a geofence manager 1501, a first set 1550 of sensor data collected by a first set 1552 of the in-flight UAVs 1554 of the UAV system, to detect a first object 1560; utilizing 1504, by the geofence manager 1501, the first set 1550 of sensor data to determine a first location 1562 of the detected first object 1560; creating 1506, by the geofence manager 1501, a geofence around the first location 1562 of the detected first object 1560; utilizing 1602, by the geofence manager 1501, a second set 1650 of sensor data collected by a second set 1652 of the in-flight UAVs 1554 of the UAV system to detect a second object 1660; utilizing 1604, by the geofence manager 1501, the second set 1650 of sensor data to determine a second location 1662 of the detected second object 1660; and determining 1606, by the geofence manager 1501, whether the second location 1662 of the detected second object 1660 is within the geofence.

However, the method of FIG. 19 also includes utilizing 1902, by the geofence manager 1501, the second set 1650 of sensor data to determine an identification 1952 of the detected second object 1660. As explained above, detecting and identifying an object may be carried out by using pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the object within the image. Additionally, or alternatively, an image of the object may be generated from LIDAR, RADAR, or SONAR sensor data. For example, line scanning LIDAR may be employed to capture a representation of the object by illuminating the object with laser light and measuring the time the reflection of the light takes to return to the sensor. Differences in return times and light wavelengths can then be used to generate a three-dimensional representation of the target.

An identification may include information and data indicating an image of the object; a classification of the object; a type of the object; or any other information that may be used to identify the object. For example, an identification associated with a vehicle may include one or more of the following types of information: color of the vehicle; designation of the vehicle as either being classified as an SUV, a car, or a truck; and length of the vehicle. As another example, an identification associated with a person may include one or more of the following types of information: hair color; eye color; face recognition information; and designation of the person as being classified as a child or an adult.

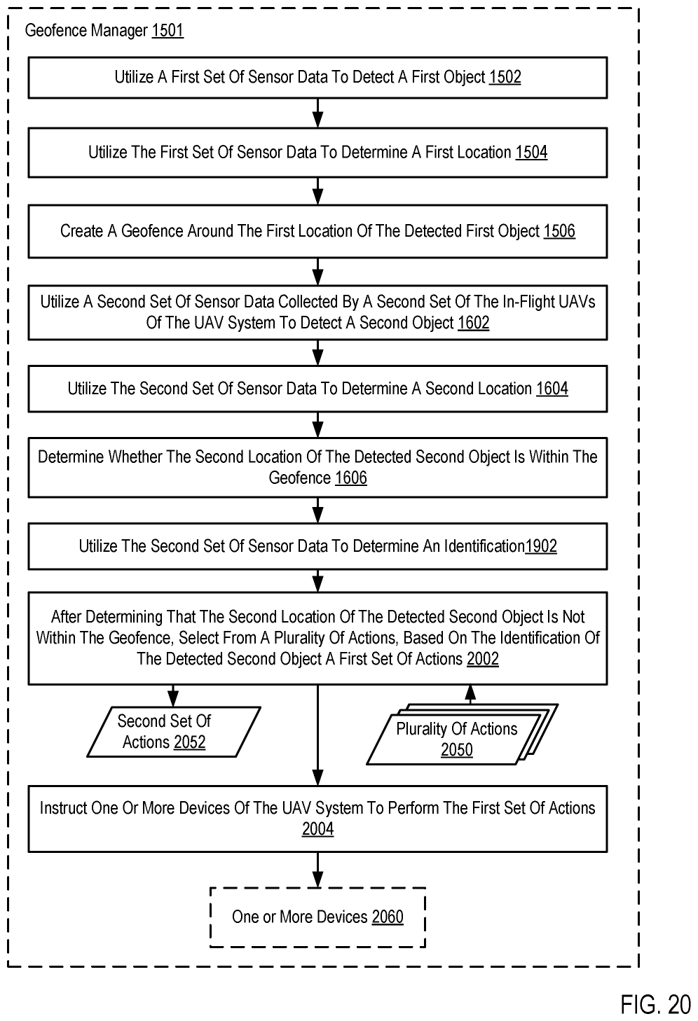

For further explanation, FIG. 20 sets forth a flow chart illustrating an exemplary method of geofence management with an unmanned aerial vehicle (UAV) in accordance with at least one embodiment of the present disclosure. The method of FIG. 20 is similar to the method of FIG. 19 in that the method of FIG. 20 also includes utilizing 1502, by a geofence manager 1501, a first set 1550 of sensor data collected by a first set 1552 of the in-flight UAVs 1554 of the UAV system, to detect a first object 1560; utilizing 1504, by the geofence manager 1501, the first set 1550 of sensor data to determine a first location 1562 of the detected first object 1560; creating 1506, by the geofence manager 1501, a geofence around the first location 1562 of the detected first object 1560; utilizing 1602, by the geofence manager 1501, a second set 1650 of sensor data collected by a second set 1652 of the in-flight UAVs 1554 of the UAV system to detect a second object 1660; utilizing 1604, by the geofence manager 1501, the second set 1650 of sensor data to determine a second location 1662 of the detected second object 1660; determining 1606, by the geofence manager 1501, whether the second location 1662 of the detected second object 1660 is within the geofence; and utilizing 1902, by the geofence manager 1501, the second set 1650 of sensor data to determine an identification 1952 of the detected second object 1660.

The method of FIG. 20 includes after determining that the second location 1662 of the detected second object 1660 is not within the geofence, selecting 2002 from a plurality 2050 of actions, based on the identification 1952 of the detected second object 1660, by the geofence manager 1501, a first set 2052 of actions. Selecting 2002 from a plurality 2050 of actions, based on the identification 1952 of the detected second object 1660, by the geofence manager 1501, a first set 2052 of actions may be carried out by referring to an index or list that associates identifications of objects with one or more actions. In a particular embodiment, actions may be object specific. For example, determining that the identification of the detected first object is a child classification may result in the selection of one set of actions and determining that the identification of the detected first object is an adult classification may result in the selection of another set of actions. As another example, detecting a “known” or “cleared” object that is on a whitelist of known/cleared/approved objects may result in one set of actions and detecting that an unknown or uncleared object that is not on the whitelist may result in another set of actions. In this example, the geofence manager may have access to a database of known or precleared people, vehicles, or objects that can leave the geofence.

In addition, the method of FIG. 20 includes instructing 2004, by the geofence manager 1501, one or more devices 2060 of the UAV system to perform the first set 2052 of actions. Instructing 2004, by the geofence manager 1501, one or more devices 2060 of the UAV system to perform the first set 2052 of actions may be carried out by executing an operation or command at the device; transmitting a message, command, instruction to the device; transmitting a message, command, or instruction to another device that relays the message, command, or instruction to the device.

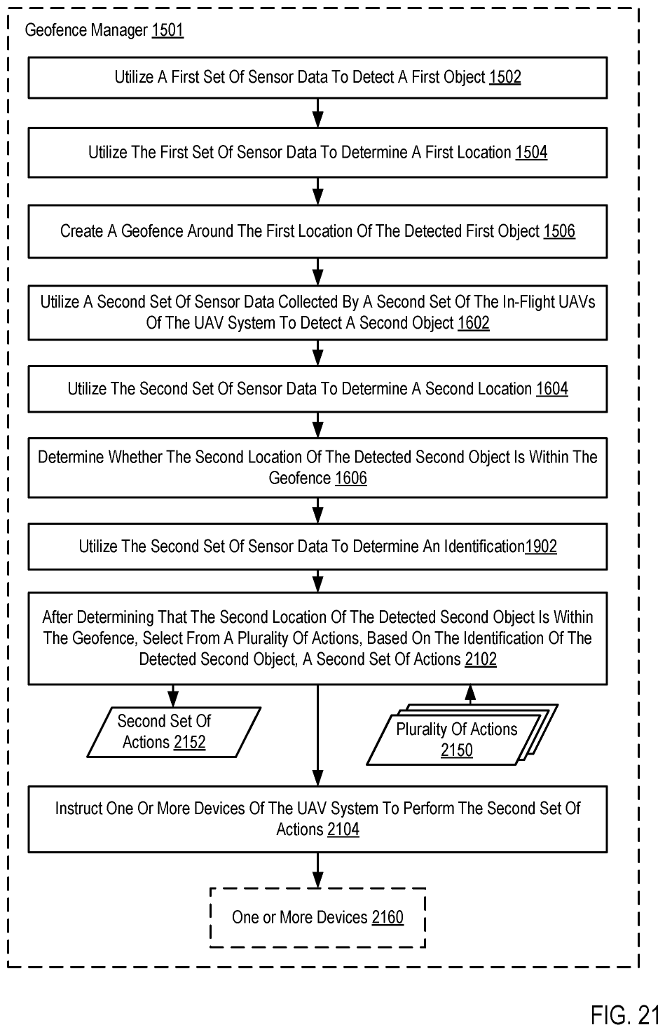

For further explanation, FIG. 21 sets forth a flow chart illustrating an exemplary method of geofence management with an unmanned aerial vehicle (UAV) in accordance with at least one embodiment of the present disclosure. The method of FIG. 21 is similar to the method of FIG. 19 in that the method of FIG. 21 also includes utilizing 1502, by a geofence manager 1501, a first set 1550 of sensor data collected by a first set 1552 of the in-flight UAVs 1554 of the UAV system, to detect a first object 1560; utilizing 1504, by the geofence manager 1501, the first set 1550 of sensor data to determine a first location 1562 of the detected first object 1560; creating 1506, by the geofence manager 1501, a geofence around the first location 1562 of the detected first object 1560; utilizing 1602, by the geofence manager 1501, a second set 1650 of sensor data collected by a second set 1652 of the in-flight UAVs 1554 of the UAV system to detect a second object 1660; utilizing 1604, by the geofence manager 1501, the second set 1650 of sensor data to determine a second location 1662 of the detected second object 1660; determining 1606, by the geofence manager 1501, whether the second location 1662 of the detected second object 1660 is within the geofence; and utilizing 1902, by the geofence manager 1501, the second set 1650 of sensor data to determine an identification 1952 of the detected second object 1660.

However, the method of FIG. 21 also includes after determining that the second location 1662 of the detected second object 1660 is within the geofence, selecting 2102 from a plurality 2150 of actions, based on the identification 1952 of the detected second object 1660, by the geofence manager 1501, a second set 2152 of actions. Selecting 2102 from a plurality 2150 of actions, based on the identification 1952 of the detected second object 1660, by the geofence manager 1501, a second set 2152 of actions may be carried out by referring to an index or list that associates identifications of objects with one or more actions.

The method of FIG. 21 also includes instructing 2104, by the geofence manager 1501, one or more devices 2160 of the UAV system to perform the second set 2152 of actions. Instructing 2104, by the geofence manager 1501, one or more devices 2160 of the UAV system to perform the second set 2152 of actions may be carried out by executing an operation or command at the device; transmitting a message, command, instruction to the device; transmitting a message, command, or instruction to another device that relays the message, command, or instruction to the device.

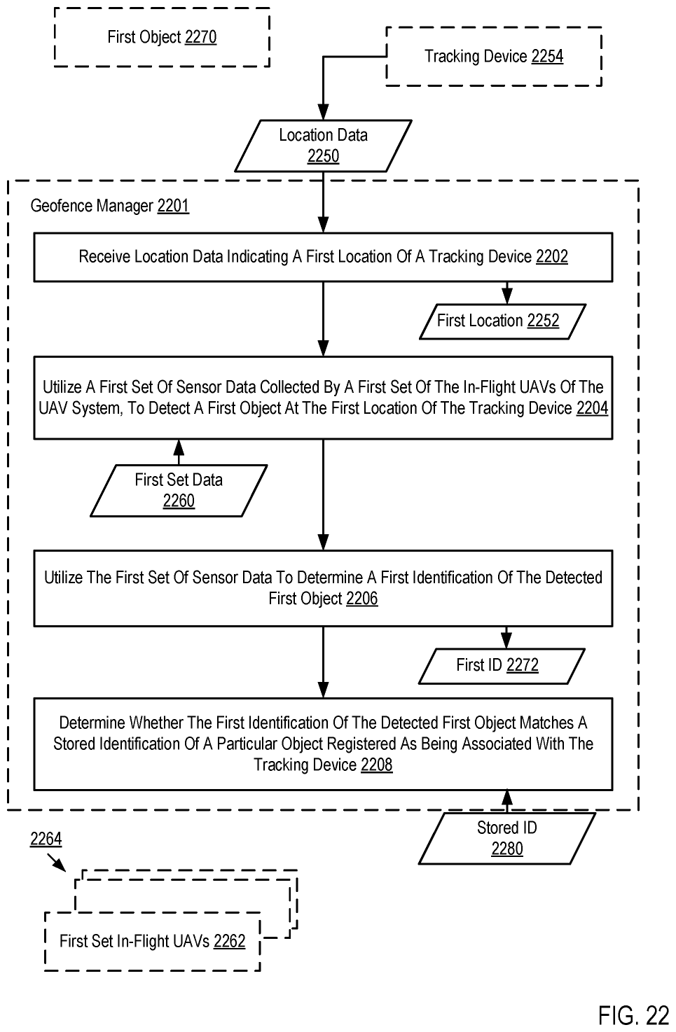

For further explanation, FIG. 22 sets forth a flow chart illustrating an exemplary method of geofence management with an unmanned aerial vehicle (UAV) in accordance with at least one embodiment of the present disclosure. A geofence manager 501 may include a set of computer program instructions that are executed by a processor. For example, the geofence manager 501 of FIG. 22 may be the geofence manager 139 of FIGS. 1 and 2 or the geofence manager 145 of FIG. 1. The method of FIG. 22 includes receiving 2202, by a geofence manager 2201, location data 2250 indicating a first location 2252 of a tracking device 2254. A tracking device may be any device that is capable of transmitting or broadcasting location data or be used to transmit a location. For example, GPS devices and satellite transceivers. Receiving 2202, by a geofence manager 2201, location data 2250 indicating a first location 2252 of a tracking device 2254 may be carried out by directly receiving the location data; receiving the location data from another device, such as a handheld device, a satellite, a cell tower, a wireless hub, and any other device that is capable of relaying information.

The method of FIG. 22 also includes utilizing 2204, by the geofence manager 2201, a first set 2260 of sensor data collected by a first set 2262 of the in-flight UAVs 2264 of the UAV system, to detect a first object 2270 at the first location 2252 of the tracking device 2254. As explained above, detecting an object may be carried out by using pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 2270 within the image. Additionally, or alternatively, an image of the first object 2270 may be generated from LIDAR, RADAR, or SONAR sensor data. For example, line scanning LIDAR may be employed to capture a representation of the first object 2270 by illuminating the first object 2270 with laser light and measuring the time the reflection of the light takes to return to the sensor. Differences in return times and light wavelengths can then be used to generate a three-dimensional representation of the target.

In addition, the method of FIG. 22 also includes utilizing 2206, by the geofence manager 2201, the first set 2260 of sensor data to determine a first identification 2272 of the detected first object 2270. An identification may include information and data indicating an image of the object; a classification of the object; a type of the object; or any other information that may be used to identify the object. For example, an identification associated with a vehicle may include one or more of the following types of information: color of the vehicle; designation of the vehicle as either an SUV, car, or truck; and length of the vehicle. As another example, an identification associated with a person may include one or more of the following types of information: hair color; eye color; face recognition information; and designation of the person as being a child or adult. Utilizing 2206, by the geofence manager 2201, the first set 2260 of sensor data to determine a first identification 2272 of the detected first object 2270 may be carried out by identifying the classification of the detected object in dependence upon the sensor data and one or more object models; and identifying object types that are particularly relevant to UAV operation and UAV missions.

The method of FIG. 22 also includes determining 2208, by the geofence manager 2201, whether the first identification 2272 of the detected first object 2270 matches a stored identification 2280 of a particular object registered as being associated with the tracking device 2254. A stored identification of a particular object registered as being associated with the tracking device may be a person, animal, vehicle, or other type of object. For example, a tracking device may be registered to a particular person have an identification (e.g., a picture of the person; a classification of the person; a type of object; etc). Determining 2208, by the geofence manager 2201, whether the first identification 2272 of the detected first object 2270 matches a stored identification 2280 of a particular object registered as being associated with the tracking device 2254 may be carried out by comparing the information and data of each identification in the set of identification to the information and data of the stored identification.

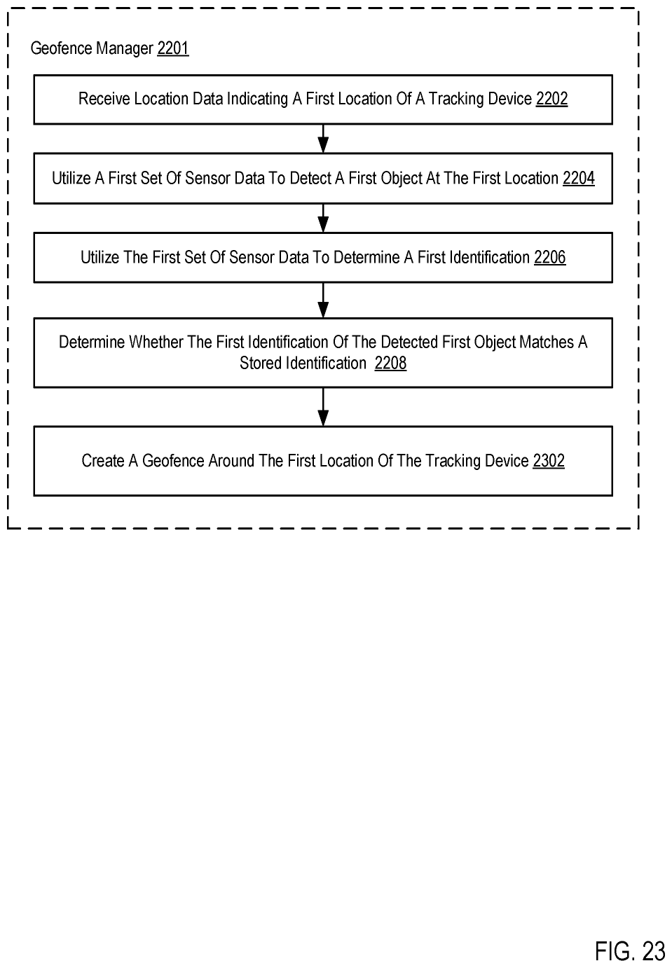

For further explanation, FIG. 23 sets forth a flow chart illustrating an exemplary method of geofence management with an unmanned aerial vehicle (UAV) in accordance with at least one embodiment of the present disclosure. The method of FIG. 23 is similar to the method of FIG. 22 in that the method of FIG. 23 also includes receiving 2202, by a geofence manager 2201, location data 2250 indicating a first location 2252 of a tracking device 2254; utilizing 2204, by the geofence manager 2201, a first set 2260 of sensor data collected by a first set 2262 of the in-flight UAVs 2264 of the UAV system, to detect a first object 2270 at the first location 2252 of the tracking device 2254; utilizing 2206, by the geofence manager 2201, the first set 2260 of sensor data to determine a first identification 2272 of the detected first object 2270; and determining 2208, by the geofence manager 2201, whether the first identification 2272 of the detected first object 2270 matches a stored identification 2280 of a particular object registered as being associated with the tracking device 2254.

The method of FIG. 23 includes creating 2302, by the geofence manager 2201, a geofence around the first location 2252 of the tracking device 2254. A geofence is a virtual perimeter around a real-world, physical, geographic area. The area around which the geofence is constructed or created may be any shape or size. The geofence may also be created in any number of ways including but not limited to a user drawing a perimeter line in a mapping application; a user providing coordinates for the perimeter; an application dynamically generating the perimeter around a fixed location or an object. Creating 2302, by the geofence manager 2201, a geofence around the first location 2252 of the tracking device 2254 may be carried out by calculating the locations of a perimeter in a radius around the second location; calculating the locations of a perimeter of a predetermined shape (e.g., a square, a rectangle); and calculating the locations of a perimeter of a computer-generated shape.

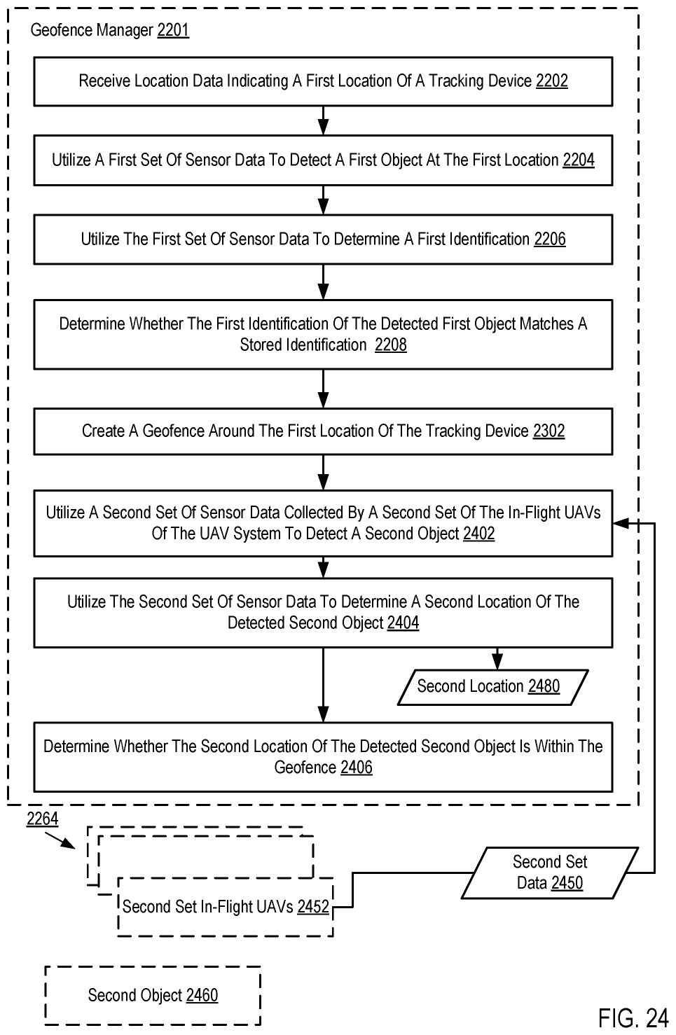

For further explanation, FIG. 24 sets forth a flow chart illustrating an exemplary method of geofence management with an unmanned aerial vehicle (UAV) in accordance with at least one embodiment of the present disclosure. The method of FIG. 24 is similar to the method of FIG. 23 in that the method of FIG. 24 also includes receiving 2202, by a geofence manager 2201, location data 2250 indicating a first location 2252 of a tracking device 2254; utilizing 2204, by the geofence manager 2201, a first set 2260 of sensor data collected by a first set 2262 of the in-flight UAVs 2264 of the UAV system, to detect a first object 2270 at the first location 2252 of the tracking device 2254; utilizing 2206, by the geofence manager 2201, the first set 2260 of sensor data to determine a first identification 2272 of the detected first object 2270; determining 2208, by the geofence manager 2201, whether the first identification 2272 of the detected first object 2270 matches a stored identification 2280 of a particular object registered as being associated with the tracking device 2254; and creating 2302, by the geofence manager 2201, a geofence around the first location 2252 of the tracking device 2254.

However, the method of FIG. 24 includes utilizing 2402, by the geofence manager 2201, a second set 2450 of sensor data collected by a second set 2452 of the in-flight UAVs 2264 of the UAV system to detect a second object 2460. Utilizing 2402, by the geofence manager 2201, a second set 2450 of sensor data collected by a second set 2452 of the in-flight UAVs 2264 of the UAV system to detect a second object 2460 may be carried out by pattern recognition techniques using machine vision. In various examples, machine vision may include visual sensors such as monocular cameras and stereo cameras, thermal imaging sensors, LIDAR sensors, SONAR sensors, and other imaging sensors that may be useful in object detection, recognition, and classification. In some examples, pattern recognition techniques are applied to a still image obtained from a camera of the UAV (e.g., the camera 112 of FIG. 1). In these examples, image processing such as contrast enhancement, color enhancement, edge detection, noise removal, and geometrical transformation may be used to isolate and enhance the first object 560 within the image. Additionally or alternatively, an image of the first object 560 may be generated from LIDAR, RADAR, or SONAR sensor data. For example, line scanning LIDAR may be employed to capture a representation of the first object 560 by illuminating the first object 560 with laser light and measuring the time the reflection of the light takes to return to the sensor. Differences in return times and light wavelengths can then be used to generate a three-dimensional representation of the target.

In addition, the method of FIG. 24 also includes utilizing 2404, by the geofence manager 2201, the second set 2450 of sensor data to determine a second location 2480 of the detected second object 2460. Utilizing 2404, by the geofence manager 2201, the second set 2450 of sensor data to determine a second location 2480 of the detected second object 2460 may be carried out by analyzing sensor data to determine a location of an object based on the relationship of the object to one or more known locations. In some examples, the location of the object may be determined based on the location of the UAV (e.g., x-y or latitude-longitude location) determined from a GPS receiver, the compass orientation of the UAV, and the distance between the UAV and the object as determined from, for example, LIDAR or SONAR data. The location of the object may be determined using a variety of techniques based on knowing the location of the UAV from a GPS receiver.

To determine the location of the object, a number of techniques may be employed to determine the distance between the UAV and the object based on the sensor data. In one example, stereo cameras are used to capture two images of the object from different viewpoints. In this example, an image processing algorithm can identify the same point in both images and calculate the distance triangulation. In another example, high frequency SONAR pulses are transmitted toward the object and the time it takes for the signal to reflect off the object and return to the UAV is used to determine the distance to the object. In yet another example, a time-of-flight camera that includes an integrated light source and a camera is used to measure distance information for every pixel in the image by emitting a light pulse flash and calculating the time needed for the light to reach the object and reflect back to the camera. In yet another example, LIDAR is used to determine how long it takes for a laser pulse to travel from the sensor to the object and back and calculate the distance from the speed of light. In still another example, image processing algorithms are used to match sequential images taken by the same camera to determine distance to objects in the image.

The method of FIG. 24 includes determining 2406, by the geofence manager 2201, whether the second location 2480 of the detected second object 2460 is within the geofence. Determining 2406, by the geofence manager 2201, whether the second location 2480 of the detected second object 2460 is within the geofence may be carried out by comparing the known location of the object to the locations or coordinates that define the geofence.

Exemplary embodiments of the present invention are described largely in the context of a fully functional computer system for managing UAV software modules. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for geofence management with an unmanned aerial vehicle (UAV) system that include one or more in-flight UAVs, the method comprising:
utilizing, by a geofence manager, a first set of sensor data collected by a first set of the in-flight UAVs of the UAV system to detect a first object;
utilizing, by the geofence manager, the first set of sensor data to determine a first location of the detected first object; and
determining, by the geofence manager, whether the first location of the detected first object is within a geofence of an area.

2. The method of claim 1 further comprising:
after determining that the first location of the detected first object is not within the geofence, instructing, by the geofence manager, one or more devices of the UAV system to perform a first set of actions.

3. The method of claim 1 further comprising:
after determining that the first location of the detected first object is within the geofence of the predefined area, instructing, by the geofence manager, one or more devices of the UAV system to perform a second set of actions.

4. The method of claim 1 further comprising:
utilizing, by the geofence manager, the first set of sensor data to determine an identification of the detected first object.

5. The method of claim 4 further comprising:
after determining that the first location of the detected first object is not within the geofence of the area, selecting from a plurality of actions, based on the identification of the detected first object, by the geofence manager, a first set of actions; and
instructing, by the geofence manager, one or more devices of the UAV system to perform the first set of actions.

6. The method of claim 4 further comprising:
after determining that the first location of the detected first object is within the geofence of the area, selecting from a plurality of actions, based on the identification of the detected first object, by the geofence manager, a second set of actions; and
instructing, by the geofence manager, one or more devices of the UAV system to perform the second set of actions.

7. The method of claim 1 further comprising:
utilizing, by the geofence manager, a second set of sensor data collected by a second set of the in-flight UAVs of the UAV system, to identify a second object;
utilizing, by the geofence manager, the second set of sensor data to determine a second location of the identified second object; and
creating, by the geofence manager, the geofence around the second location of the identified second object.

8. The method of claim 1 further comprising:
receiving, by the geofence manager, location data indicating a third location of a tracking device;
utilizing, by the geofence manager, a third set of sensor data collected by a third set of the in-flight UAVs of the UAV system, to determine a set of identifications of any objects within a predetermined proximity to the third location of the tracking device; and
determining, by the geofence manager, whether at least one identification of the set of identifications matches a stored identification of a particular object registered as being associated with the tracking device.

9. The method of claim 8 further comprising:
after determining that at least one identification of the set of identifications does match the stored identification of the particular object registered as being associated with the tracking device, instructing, by the geofence manager, one or more devices of the UAV system to perform a first set of actions.

10. The method of claim 8 further comprising:
after determining that at least one identification of the set of identifications does not match the stored identification of the particular object registered as being associated with the tracking device, instructing, by the geofence manager, one or more devices of the UAV system to perform a second set of actions.

11. A method of geofence management with an unmanned aerial vehicle (UAV) system that include one or more in-flight UAVs, the method comprising:
utilizing, by a geofence manager, a first set of sensor data collected by a first set of the in-flight UAVs of the UAV system, to detect a first object;
utilizing, by the geofence manager, the first set of sensor data to determine a first location of the detected first object; and
creating, by the geofence manager, a geofence around the first location of the detected first object.

12. The method of claim 11 further comprising:
utilizing, by the geofence manager, a second set of sensor data collected by a second set of the in-flight UAVs of the UAV system to detect a second object;
utilizing, by the geofence manager, the second set of sensor data to determine a second location of the detected second object; and
determining, by the geofence manager, whether the second location of the detected second object is within the geofence.

13. The method of claim 12 further comprising:
after determining that the second location of the detected second object is not within the geofence, instructing, by the geofence manager, one or more devices of the UAV system to perform a first set of actions.

14. The method of claim 12 further comprising:
after determining that the second location of the detected second object is within the geofence, instructing, by the geofence manager, one or more devices of the UAV system to perform a second set of actions.

15. The method of claim 12 further comprising:
utilizing, by the geofence manager, the second set of sensor data to determine an identification of the detected second object.

16. The method of claim 15 further comprising:
after determining that the second location of the detected second object is not within the geofence, selecting from a plurality of actions, based on the identification of the detected second object, by the geofence manager, a first set of actions; and
instructing, by the geofence manager, one or more devices of the UAV system to perform the first set of actions.

17. The method of claim 15 further comprising:
after determining that the second location of the detected second object is within the geofence, selecting from a plurality of actions, based on the identification of the detected second object, by the geofence manager, a second set of actions; and
instructing, by the geofence manager, one or more devices of the UAV system to perform the second set of actions.

18. A method of geofence management with an unmanned aerial vehicle (UAV) system that include one or more in-flight UAVs, the method comprising:
receiving, by a geofence manager, location data indicating a first location of a tracking device;
utilizing, by the geofence manager, a first set of sensor data collected by a first set of the in-flight UAVs of the UAV system, to detect a first object at the first location of the tracking device;
utilizing, by the geofence manager, the first set of sensor data to determine a first identification of the detected first object; and
determining, by the geofence manager, whether the first identification of the detected first object matches a stored identification of a particular object registered as being associated with the tracking device.

19. The method of claim 18 further comprising:
creating, by the geofence manager, a geofence around the first location of the tracking device.

20. The method of claim 19 further comprising:
utilizing, by the geofence manager, a second set of sensor data collected by a second set of the in-flight UAVs of the UAV system to detect a second object;
utilizing, by the geofence manager, the second set of sensor data to determine a second location of the detected second object; and
determining, by the geofence manager, whether the second location of the detected second object is within the geofence.
